(19) United States
(12) Patent Application Publication
(10) Pub. No.: US 2026/0264690 A1
(43) Pub. Date: Sep. 10, 2026

(54) DRIVING MODES FOR A VEHICLE

(71) Applicant: Volvo Car Corporation, Göteborg (SE)

(72) Inventors: Daniel YOUNG, Göteborg (SE); Derek BOESCH, Göteborg (SE); Andrew FIORINO, Göteborg (SE); William FIGUEROA, Göteborg (SE); Giovanni SPIRITOSO, Göteborg (SE); Josh CRIM, Göteborg (SE); Brian BURGARD, Göteborg (SE); Peter BARCIA, Göteborg (SE)

(73) Assignee: Volvo Car Corporation, Göteborg (SE)

(21) Appl. No.: 19/069,447

(22) Filed: Mar. 4, 2025

(51) Int. Cl. B60W 30/182; B60W 50/08; B60W 50/14; B60W 60/00

(52) U.S. Cl. CPC B60W 30/182; B60W 50/082; B60W 50/14; B60W 60/001; B60W 2050/146; B60W 2556/10; B60W 2556/45

(57) ABSTRACT

Embodiments relate to a system and method related to driving modes of a vehicle. The method includes receiving a first input via a driving mode selection interface to select a driving mode of a vehicle, determining a vehicle system of the vehicle based on the driving mode, receiving a second input to modify a setting of the vehicle system, wherein the setting is from a plurality of settings, and communicating, via a communication module, the setting to the vehicle system. The method further includes actuating an operation of the vehicle system based on the setting.

### FIELD OF DISCLOSURE

This disclosure relates to the field of driving modes for a vehicle. The disclosure is more particularly related to the integration of driving modes that alter multiple operational settings of a vehicle.

### BACKGROUND

Some vehicles allow the selection between different driving modes. For example, selectable sport and economy modes are included in many late model vehicles. Such modes typically alter performance of the vehicle via modification of the algorithm that controls response of the engine to the position of the throttle pedal (e.g., the pedal controller). In an economy mode and/or regular mode, some vehicles engage start/stop technology to conserve charge/fuel while the vehicle is stopped at a red light, etc. In other vehicles, a sport mode and a normal/comfort mode may alter the inflation of air bladders included in the suspension. Thus, the stiffness of the ride may be controlled via a driving mode. However, no vehicles include integration of driving modes that alter multiple operational settings of a vehicle.

Therefore, there is a need for a system configured to alter the operation of several vehicle systems.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect, the present disclosure relates to a system comprising a driving mode selection interface; a communication module; and a processor storing instructions in a non-transitory memory that, when executed, cause the processor to: receive a first input via the driving mode selection interface to select a driving mode of a vehicle; determine a vehicle system of the vehicle based on the driving mode; receive a second input to modify a setting of the vehicle system, wherein the setting is from a plurality of settings; communicate, via the communication module, the setting to the vehicle system; and actuate an operation of the vehicle system based on the setting.

In another aspect, the present disclosure relates to a method comprising receiving a first input via a driving mode selection interface to select a driving mode of a vehicle; determining a vehicle system of the vehicle based on the driving mode; receiving a second input to modify a setting of the vehicle system, wherein the setting is from a plurality of settings; communicating, via a communication module, the setting to the vehicle system; and actuating an operation of the vehicle system based on the setting.

In another aspect, the present disclosure relates to a non-transitory computer-readable storage medium having stored thereon instructions executable by a computer system to perform operations comprising receiving a first input via a driving mode selection interface to select a driving mode of a vehicle; determining a vehicle system of the vehicle based on the driving mode; receiving a second input to modify a setting of the vehicle system, wherein the setting is from a plurality of settings; communicating, via a communication module, the setting to the vehicle system; and actuating an operation of the vehicle system based on the setting.

### BRIEF DESCRIPTION OF THE FIGURES

These and other aspects of the present disclosure will now be described in more detail, with reference to the appended drawings showing exemplary embodiments of the present disclosure, in which:

FIG. 1 illustrates a block diagram of a driving mode selection system according to an embodiment.

FIG. 2A is an illustration of a vehicle with various sensors arranged strategically according to an embodiment.

FIG. 2B illustrates a block diagram of electronic components of the vehicle according to an embodiment.

FIG. 3 illustrates the driving modes available, and the vehicle systems modified according to one or more embodiments.

FIG. 4 illustrates the selection of driving modes of a vehicle according to an embodiment.

FIG. 5 illustrates steps executed by a system according to an embodiment.

FIG. 6 illustrates a block diagram of the method executed by the non-transitory computer-readable storage medium according to an embodiment.

FIG. 7 illustrates a communication flow between the system and the vehicle according to one or more embodiments.

FIG. 8 illustrates a flow diagram for a vehicle driving in an autonomous mode along with user specific or other driving modes according to one or more embodiments.

FIG. 9 illustrates an example block diagram for an Artificial Intelligence and Machine Learning (AI/ML) model used in a system according to an embodiment.

FIG. 10A illustrates a structure of the neural network/machine learning model with a feedback loop according to an embodiment.

FIG. 10B illustrates a structure of the neural network/machine learning model with reinforcement learning according to an embodiment.

FIG. 11A illustrates a block diagram of the cyber security module in view of the system and server according to an embodiment.

FIG. 11B illustrates a block diagram of the cyber security module according to an embodiment.

FIG. 11C illustrates another block diagram of the cyber security module according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present disclosure may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the disclosure can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Controller (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication unit” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example of communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware. In an example, the second component can be another vehicle capable of receiving and transmitting information with the first vehicle.

The term “alert” or “alert signal” refers to a communication to attract attention. An alert may include visual, tactile, audible alert and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable storage medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” or “user” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products and/or data processing device which may be a core computer according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions. Some of the method may be performed in the cloud, or by some other remote server.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “monitoring” refers to systematic observation and assessment of a system, process, or environment in real-time or near real-time. It involves the regular collection, analysis, and interpretation of data using various sensors. Monitoring may be continuous or adaptive.

The term “vehicle system” or “computer system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device, or receiving a message from a user device. The designed system comprising instructions may also be using existing systems present on the vehicle, for example, a communication system of the vehicle.

The term “battery” as used herein refers to a battery system in the vehicle, wherein the battery system may be used for starting the vehicle or may be used for operating the vehicle. The battery system may also be used to enable the vehicle to run.

The term “user” as used herein refers to any individual who is a driver or an owner or a user of the vehicle. Broadly, it may encompass any individual having the possession of the vehicle.

The term “external to the vehicle” or “exterior of the vehicle” refers to the outside of the vehicle. The sound exterior of the vehicle may refer to the sound heard on the outside of the vehicle.

The term “safety zone” or “safe zone” or “contact free zone” of a vehicle refers to the area immediately surrounding a vehicle where extra caution and safety measures should be taken to avoid accidents or hazards. This zone may vary depending on the type of vehicle, its size, and the circumstances, but it generally extends a certain distance around the vehicle. Safe zones may include the space around the vehicle, to the front, sides, and rear, typically within a few feet or meters. This area varies depending on whether the vehicle is stationary or moving at low speeds, size of the vehicle, weight of the vehicle, whether the vehicle is changing lanes, speeding up, or overtaking other vehicles, in addition to considering any attachments forming a vehicle combination. Larger vehicles such as buses, trucks, or heavy machinery have larger safety zones due to their size and blind spots. These larger vehicles may often have specific blind spots or “no-zones” where the driver's visibility is limited. Determining the proper safety zone of a vehicle, and maintaining the same, ensures road safety and prevents accidents. The safety zone may be specified in feet or meters around the vehicle as a circular region or it can vary on each side of the vehicle. In an embodiment, the safety region could be a rectangular region. In another embodiment, the front safety region may be different from the back safety region, the left side safety region may be different from right side safety region, etc., depending on the vehicle combination, vehicle combination actions, and surroundings. The safety regions or zone may be adaptive, meaning the system may have the ability to adjust or modify the safety regions or zone in response to varying conditions, circumstances, or input. In an embodiment, the safety zone may be an adaptive smart safety zone. The system may determine an adaptive smart safety zone or regions by utilizing active data from sensors and intelligent technologies and dynamically adjust the safety zone or regions based on changing conditions.

The term “vehicle dynamics” as used herein refers to vehicle motion and vehicle maintaining traction. Vehicle dynamics may be used to predict and control the motion of the vehicle.

The term “nearby vehicle” or “neighboring vehicle” or “surrounding vehicle” as used herein refers to a vehicle anywhere near to the referred vehicle within a communication range of the referred vehicle, wherein the communication range is defined as the maximum distance where communication can exist between two antennas, one of which is the user's vehicle antenna in a wireless network. A nearby vehicle may or may not be an autonomous vehicle. It may or may not have been enabled for V2V communication. In some embodiments, a neighboring vehicle may more specifically refer to a vehicle that is immediately in the next lane or behind the vehicle.

Business problem: Some vehicles have one or more driving modes available in the vehicle, and the vehicle allows selections, for the driver or user of the vehicle, of different vehicle settings of the selected driving mode. For example, selectable sports mode and economy mode are included in many late model vehicles. Such modes typically alter performance of the vehicle via modification of the algorithm that controls response of the engine. However, no vehicles include integration of driving modes that alter multiple operational settings across multiple systems of the vehicle. Current driving modes do not provide the user with the experience or interaction to modify multiple vehicle systems, and do not allow for the user to make the most of the vehicle capabilities.

Technical problem: Some vehicles allow the selection between different driving modes. For example, selectable sports mode and economy modes typically alter performance of the vehicle via modification of the algorithm that controls response of the engine to the position of the throttle pedal (e.g., the pedal controller). In an economy mode and/or regular mode, some vehicles engage start/stop technology to conserve charge/fuel while stopped at red lights, etc. In other vehicles, a sports mode and a normal/comfort mode may alter the inflation of suspension bags included in the suspension system. Thus, the stiffness of the ride may be controlled to a degree. However, no vehicles include integration of driving modes that alter multiple operational settings across multiple systems of the vehicle. Current driving modes do not appreciably modify the user experience/interaction with vehicle communication/reporting/warning systems. Further, current driving modes do not alter the operation of an autonomous driving system of the vehicle.

Business solution: A driving mode system is provided where a driving mode, or the like, is configured to alter the operation of several vehicle systems. For example, a turbo mode or a warp mode may alter or modify up to every system of the vehicle. The system may allow for the user to individually select which systems are modified. The mode settings allow the operator/user to enjoy an exhilarating ride without the annoyance and distraction of non-critical vehicle warnings, alerts, and the like.

Technical solution: The system may allow for the user to individually select a driving mode and select which vehicle systems, of the multiple vehicle systems, are modified, along with the degree of modification via an infotainment unit, mobile device, app., etc. For example, in a warp mode, the gain/response of the pedal controller may be increased, the automatic transmission shift schedule algorithm may be modified to run in lower gears/settings, the power/torque may be increased, the stiffness of the suspension may be increased.

Technical Result: The present system provides user selectable driving mode settings that are configured to alter the operation of several vehicle systems. The system allows the user to individually select vehicle systems to be modified. The system provides user specific driving experience by allowing the user to further select the degree of modification to each of the vehicle systems. The present system addresses the limitations of existing driving mode technologies, providing a more exhilarating experience for the user of the vehicle.

How a Technical Solution is a Technological Advancement: The system is designed to integrate driving modes that alter multiple operational settings of a vehicle. The system leverages advanced technologies, including machine learning, bidirectional communication, and integration of multiple driving modes that alter several operational settings of a vehicle.

A vehicle generally represents various types of passenger vehicles, such as crossover utility vehicle (CUV or XUV), sport utility vehicle (SUV), truck, recreational vehicle (RV), hybrid vehicle, etc., including driver operated, driver-assisted, and fully autonomous configurations for transporting people or goods. The vehicle may include a computing platform that provides telematics services including navigation, turn-by-turn directions, vehicle health reports, local business search, accident reporting, and hands-free calling, for example. The vehicle may be powered by an internal combustion engine, a battery or one or more electric machines that may be operated as a motor/generator. The vehicle may include various types of transmission or gear box configurations including, for example, a power split configuration, a continuously variable transmission (CVT), or a step-ratio transmission. The term hybrid is used often with electric vehicles. A hybrid vehicle may use two or more distinct types of power. Electric input puts the vehicle into electric mode. The type of hybrid may be petroleum-electric hybrid drivetrains, that may range from full hybrid to mild hybrid. In addition to vehicles that use two or more different devices for propulsion, there are also vehicles that use distinct energy sources or input types (“fuels”) using the same engine to be hybrids and are also described as dual mode vehicles. The hybrid vehicle may be a fluid power hybrid, petro-air hybrid, or petro-hydraulic hybrid.

Drive modes are a way of adjusting the driving dynamics of a vehicle. The adjustment may be to match current road conditions or personal driving preference of the user of the vehicle. In an embodiment, drive modes may alter one or more of a transmission system, a steering system, a pedal controller, a throttle system, an automatic transmission shift, a suspension system, a braking system, a turning system, an ancillary system, a sound system, and overall performance of the vehicle according to the present disclosure. Signals to and from the engine and transmission control modules are manipulated when a driving mode is chosen. The present disclosure provides mechanisms to modify one or more of the vehicle systems as mentioned above, on the go, to meet the driver's/occupant's preferences. The setting of the vehicle system may be modified using the driving mode selection interface. The setting of the vehicle system may be selected from the plurality of settings, providing threshold range, maximum value to minimum value, any available driving mode setting to the operation of a vehicle system.

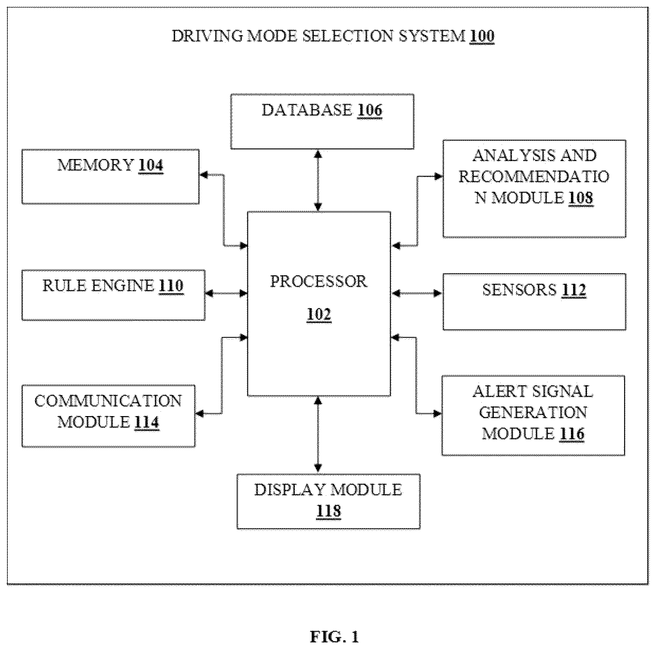

Technical Details Specific to the Technical Solution: FIG. 1 illustrates a block diagram of a driving mode selection system according to an embodiment.

Driving mode selection system 100 comprises processor 102, memory 104, database 106, analysis and recommendation module 108, rule engine 110, sensors 112, communication module 114, alert signal generation module 116, and display module 118.

Referring to FIG. 1, processor 102 may be a high-performance, multi-core CPU or system-on-chip (SoC) solution to process vast amounts of data. In some embodiments, processor 102 processes data from database 106, sensor 112, and other inputs to make real-time decisions related to modifications to a setting of a vehicle system based on a selected driving mode. The processor may make real-time decisions whether the degree of modification made by a user to a setting of a vehicle system is acceptable. Processor 102 further processes data to make real-time decisions regarding the simultaneous operation of a driving mode, such as a warp mode, along with an autonomous mode. While driving in autonomous mode, the processor may allow modification to a setting of a vehicle system so as to engage another driving mode of the vehicle along with the autonomous mode. Processor 102 may comprise Graphics Processing Units (GPUs). GPUs are utilized for their ability to accelerate tasks like data processing. The processor may depend on factors such as processing requirements and power consumption. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze input data received from the user through a driving mode selection interface and determine preferred modifications to the settings of one or more vehicle systems for a driving mode, for simultaneous operation along with an autonomous mode of the vehicle, interpret the environment, and help in decision making. In an embodiment, the processor may be a neuromorphic processor, inspired by the human brain, which offers a unique approach to handling AI tasks. Processor 102 interacts and exchanges data with one or more of the other components or modules of the system, and computes and processes the input received to select a driving mode, determines a vehicle system of the vehicle based on the driving mode, receives an input to modify a setting of the vehicle system and modifies an operation of the vehicle system based on the setting, and controls and coordinates memory 104, database 106, analysis and recommendation module 108, rule engine 110, sensors 112, communication module 114, alert signal generation module 116, and display module 118. The processor may determine the setting of a vehicle system in real-time to carry out a modification to the operation of the vehicle system.

Referring to FIG. 1, memory 104 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high speed operation and low power consumption. In an embodiment, the memory may be a cloud-based memory. In another embodiment, the memory may be a local memory. In another embodiment, the memory may be a combination of local and cloud-based memory. Local memory refers to the traditional memory components present in a physical device, such as a computer's RAM, hard disk drives (HDDs), or solid-state drives (SSDs). It provides fast access to data, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 1, in some embodiments, database 106 may store data associated with analysis and recommendation module 108, rule engine 110, sensors 112, communication module 114, alert signal generation module 116, and display module 118. In some embodiments, database 106 may be locally present in system 100 or may be present in a cloud server. Processor 102 may fetch the data from the database to determine the vehicle systems that may require modification of a setting based on a selected driving mode of the vehicle.

Referring to FIG. 1, analysis and recommendation module 108 may develop strategies by collecting and analyzing diverse sets of data based on the selection of a driving mode from vehicle driving selection interface and the modifications to the setting of a vehicle system based on the selected driving mode and provide to the processor 102. The analysis and recommendation module 108 may calculate the threshold setting range for a modification to the vehicle system. For example, if the warp mode is selected, the range of speed for the vehicle may range from 50 miles per hour (mph) to the maximum speed attainable by the vehicle. Further, the settings to the suspension system may be provided as a bar, ranging from soft suspension to tight suspension. For a warp mode, the setting on the bar for the suspension system may range from mid bar towards tight suspension. In response to encountering a condition, such as terrain or traffic, the analysis and recommendation module 108 may recommend a transition to a lower operational setting for a vehicle system or recommend a transition to a lower operational driving mode. Leveraging machine learning algorithms, Artificial Intelligence (AI) may predict the potential vehicle systems that may need modification for a driving mode. For example, the economy mode may require modifications to the throttle system, transmission system, and suspension system, whereas in warp mode, modifications may be made for other systems as well, such as steering system, braking system, sound system, etc.

By considering factors like terrain, weather, traffic, user behavior, and vehicle behavior, AI can estimate the settings needed with a higher degree of accuracy; and the estimation, using predictive analytics, relies on advanced machine learning algorithms to analyze a wealth of vehicle data, driving mode data, setting data of a vehicle system, modifications to the various vehicle systems, user data, and various driving conditions. The process may comprise data collection and preprocessing, where historical vehicle data on settings of a vehicle system, energy consumption, speed, acceleration, stability, maneuverability, and driving behavior is combined with real-time information on weather conditions, traffic, and terrain. Relevant features are extracted from this comprehensive data set for predicting the needed settings of the vehicle systems.

An appropriate machine learning algorithm is selected that can provide the estimation for the set of devices. Examples include regression models, such as Bayesian regression, neural network regression and decision forest regression, time series analysis, neural networks, and decision matrix algorithms such as gradient boosting (GDM) and Adaptive Boosting (AdaBoosting). The chosen model is then trained on the preprocessed dataset to understand the relationships between different variables and their impact on the vehicle's and user's safety range. Predictive analytics further integrates real-time data. The model continuously incorporates up-to-date information on driving modes, settings available to a vehicle system, weather conditions, traffic patterns, and other relevant factors, ensuring that the predictions are adaptive and responsive to dynamic driving conditions for the selected driving mode. Predictive analytics can also optimize the route to maximize safety and maneuverability.

The rule engine 110 may be configured to execute one or more rules, e.g., in a planned, scheduled, and/or ordered manner. The rules may be generated by the analysis and recommendation module 108 or an AI rule generator, which uses artificial intelligence to formulate rules to enable future oriented determination of settings to the one or more vehicle systems based on the selected driving mode and settings to the vehicle systems when the vehicle is operating in an autonomous mode. The rules enable the various workflows to be triggered. Servers may be configured in hardware terms according to the specified requirements for determination of vehicle settings. In one example the servers are GIGABYTE's H-Series, family of high density multi-node, servers. The rule engine may include diverse technologies for collection, processing, storage, and distribution of data such as in Smart Phones, iPads, Desktop/Personal Computers, Stand-alone/On-Premise/Cloud Servers, and the like. Each device and server comprise digital data processors and communication interfaces as is well known in the art.

The sensor(s) 112 may include a variety of sensors for monitoring the operation and/or environment in which a vehicle may be operating. The sensor(s) may include, but are not limited to, tire pressure sensors, tire blowout sensors, cameras, water sensors, collision sensors, traction control sensors, speed sensors, brake sensors, scales, radio frequency identification receivers, a vehicle computer, etc. The vehicle may be a car, van, etc. The vehicle may include an electronic navigation system including a global positioning system (GPS) receiver. The vehicle may include a variety of sensors for monitoring the vehicle in a particular driving mode. The sensors may be connected (e.g., using CAN bus, etc.) to an onboard computing platform 202, as will be described below, that uses inputs received from the sensors, to assist in making modifications to the settings of the various vehicle systems for a selected driving mode. In the case of an autonomous mode, similar sensors may be utilized. The GPS receiver may collect location information as the vehicles travel along a roadway. In an example, a first image may be obtained of the vehicle from the sensor data. For example, an image may be received from a camera included in the sensor(s). In an example, a measurement may be obtained between the vehicle and the sensor(s) from the sensor data. For example, a distance measurement may be obtained between a tire of the vehicle and a depth sensor included in the sensor(s). The data may be obtained directly from sensor(s), camera and/or from the onboard computer of the vehicle. The information received from the sensors mentioned herein may be the information related to the vehicle systems that is received by the processor in order to provide a modification to a setting of the vehicle system. The information may include images, measurements, and other data that may be used to provide assistance to the driver of the vehicle.

Referring to FIG. 1, sensors 112 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In an embodiment, the sensors 112 may comprise a millimeter-wave radar, an image identification device, a short-range wireless device, or an optical communication device capable of detecting the location and angle of movement of the vehicle. According to an embodiment of the system, one or more sensors comprise a magnetic sensor, a proximity sensor, a load sensor, an electrical sensor, and a vision sensor. In an embodiment, the sensors may comprise a plurality of multi-modal sensory arrays, that may include a plurality of microphones for obtaining audio information, a plurality of video cameras for obtaining video information, and one or more movement-related sensors for obtaining vehicle movement-related information.

The sensors may also include a global positioning system (GPS), an incline sensor, one or more battery sensors, a speed sensor, and one or more clutch sensors. In some embodiments, the vehicle may include additional or different sensors configured to measure or monitor various operational parameters of the powertrain, and/or the vehicle. For example, the sensors may include speed sensors that are configured to measure an angular speed of the engine, the pump clutch, the electromechanical transfer device (ETD) clutch, and/or various components of the ETD, etc. The sensors may be integrated into various systems, subsystems, etc., of the vehicle. For example, the sensors can be integrated into or communicably coupled with an engine control unit (ECU) 208 of the vehicle.

The incline sensor may be any sensor configured to provide an incline of the vehicle (e.g., an indication of the grade upon which the vehicle is currently traveling, an angle of the vehicle relative to the direction of gravity, etc.). By way of example, the incline sensor may be or include an inclinometer or a gyroscopic sensor. Alternatively, the GPS may include the incline sensor. By way of example, sensor data from the GPS indicating the current global location of the vehicle may be correlated to the incline at various global locations. The controller or the GPS may store data correlating global locations to associated inclines at those locations. Based on the current global location, the current speed and direction of travel (e.g., provided by the speed sensor and/or the GPS), and the data correlating global locations to corresponding inclines, the controller may be configured to determine a current incline and/or predict a future incline of the vehicle based on sensor data. The processor may transition the vehicle from one driving mode to another driving mode based on the sensor data.

The speed sensor may be any sensor that is configured to measure the velocity of the vehicle. For example, the speed sensor may be positioned at the front wheels and/or the rear wheels of the vehicle. The clutch sensors may be configured to monitor a status (e.g., engaged, dis-engaged, etc.) of the pump clutch and/or the ETD clutch and provide the status of the pump clutch and/or the ETD clutch to the controller. It should be understood that the controller can be communicably coupled with the ECU and/or a transmission control unit (TCU) of the vehicle and may receive any of the information or data of any of the systems, subsystems, control units, etc., of the vehicle.

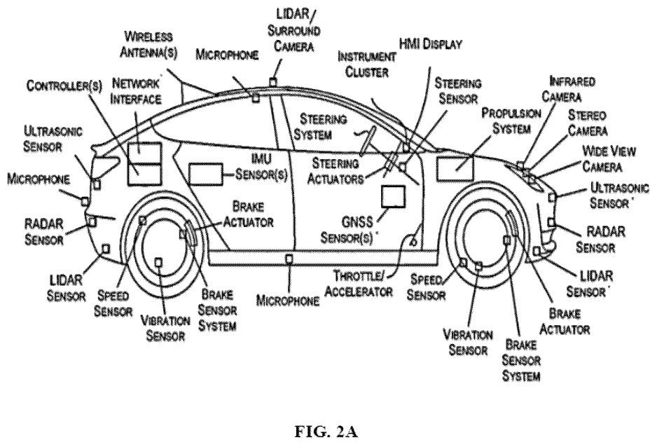

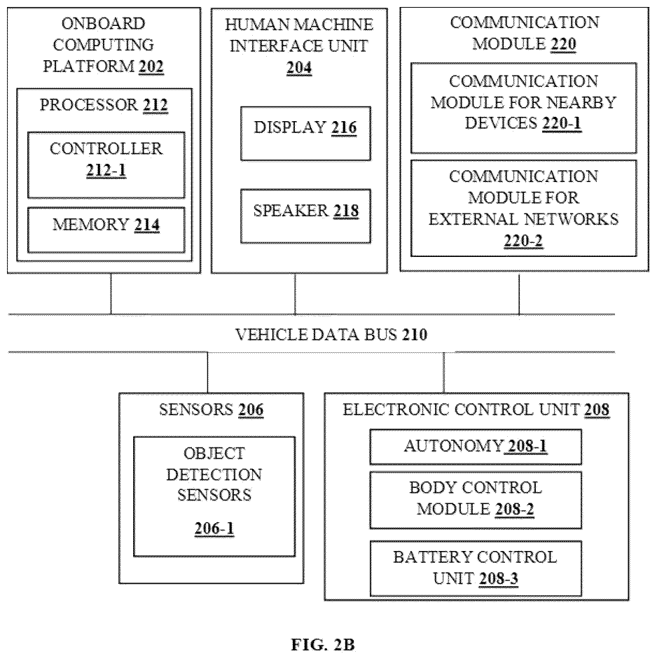

Sensors 112: FIG. 2A is an illustration of a vehicle with various sensors, actuators, and systems according to an embodiment. The system comprises various sensors, such as ultrasonic sensors, LIDAR sensors, radar sensors, camera-based sensors, infrared (IR) sensors, etc. FIG. 2A is depicted as an example system; neither is it limited by the systems depicted nor is it an exhaustive list of the sensors, actuators, and systems/subsystems, and/or features of the vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the vehicle. In case of autonomous vehicles, also known as self-driving vehicles or driverless vehicles, they can navigate and operate without human intervention. Sensors, for example, cameras, camera-based sensors, LIDARs, radars, optical sensors, laser sensors, speed sensors, motion sensors, and ultrasonic sensors, enable autonomous vehicles to detect and recognize objects, obstacles, and pedestrians on the road.

In an embodiment, sensors are activated to continuously monitor the surroundings and the road conditions. In an embodiment, sensors are activated to periodically monitor the surroundings and the road conditions.

In an embodiment, capacitance-based sensors are used. Sensor fusion approach may be used that allows the system to leverage the strengths of each sensor type and provide comprehensive perception of the detection of the surroundings of the vehicle. Sensor fusion is the process of combining data from multiple sensors to improve the accuracy, reliability, and efficiency of the information collected. It involves integrating information from various sources, such as cameras, radar, LIDAR, and other sensors, to obtain a more complete and more accurate picture of the environment. Sensor fusion may be able to reduce errors and uncertainties that can arise from using a single sensor and to obtain a more comprehensive understanding of the surrounding world. By combining data from multiple sensors, from settings of driving modes and vehicle settings, vehicle systems can make more informed decisions and respond to changing conditions in real-time. According to an embodiment, an AI-based integration of warp mode and autonomous mode may be used in combination with sensor fusion techniques. Some of the algorithms that are suitable may include but are not limited to: (i) Hough Transform, (ii) Convolutional Neural Networks (CNNs). The sensors may select a region of a road of travel of the vehicle based on sensor data indicative of the road of travel based on a speed and the location of the vehicle and based on the speed and location of the nearby vehicles, and the processor may determine a driving mode having a setting for the plurality of vehicle systems of the vehicle. The driving mode may include, for example, settings to the vehicle systems comprising a “safe” speed and/or applicable speed limit, whichever is lower.

Referring to FIG. 1, communication module 114 is coupled to processor 102. In some embodiments, communication module 114 facilitates communication between different vehicle systems within system 100, communication between the vehicle and other vehicles and other infrastructure components. Further it facilitates communication of a setting of the vehicle system to modify an operation of the vehicle system. The communication module 114 enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G), and Vehicle to everything (V2X) communication systems. Thus, communications with the vehicle systems may be through one or more interfaces, including but not limited to Universal Serial Bus (USB), Media Oriented System Transport (MOST) bus, Control Area Network (CAN) bus, Ethernet, Universal Asynchronous Receiver-Transmitter (UART), Serial Peripheral Interface (SPI). The vehicle uses a message protocol, for example, a message that goes to the other vehicles via a broadcast. The communication module 114 may comprise hardware such as an audio or video recorder and software such as methods, programs and algorithms that would enable recording the data from external devices. In an embodiment, the communication module 114 may provide content, information, data, and/or media associated with the vehicle and one or more devices such as mobile phones, a device that is located or associated with the vehicle, a wearable device, wearable computer, and the like.

The information from the user device or mobile device or cloud platform may further be transmitted or received over a communications network using a transmission medium via the communication module utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet mobile telephone networks (e.g., cellular networks), Plain Old Telephone (POTS) networks), and wireless data networks (e.g., Institute of Electrical and. Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the communication module may include one or more physical jacks (e.g., Ethernet, coaxial, or phone jacks) or one or more antennas to connect to the communications network. In an example, the communication module may include a plurality of antennas to wirelessly communicate with, using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the vehicle, and includes digital or analog communications signals or other intangible medium to facilitate communication of such software. The communication module may comprise a hardware component comprising a microcontroller, a transceiver, a power management integrated circuit, an Internet of Things device capable of transmitting one of an analog and a digital signal over one of a telephone, a communication either wired or wirelessly, etc.

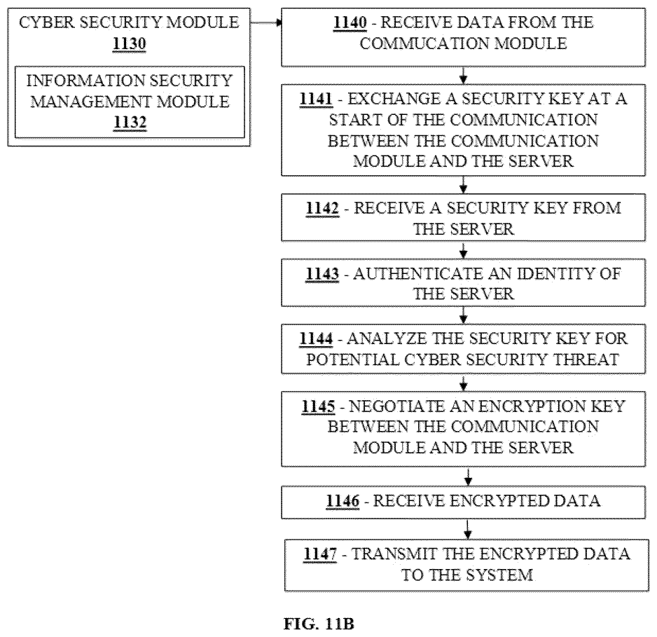

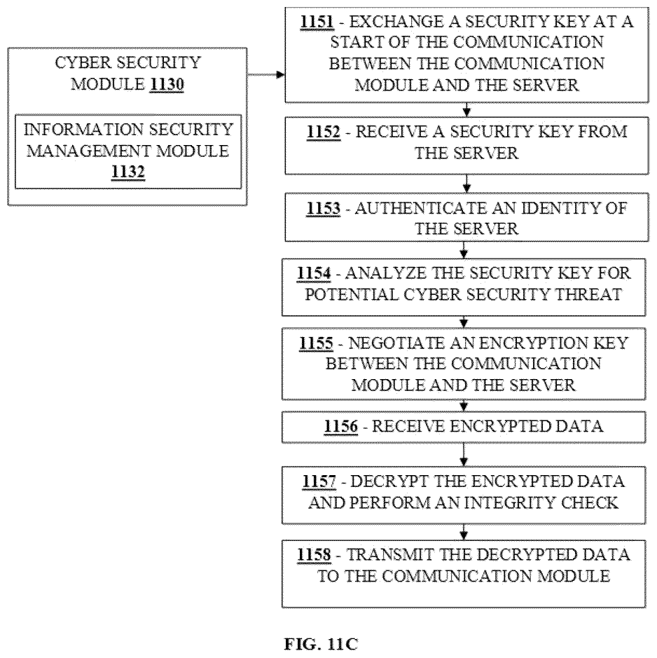

In an embodiment, communication module 114 may comprise a cyber security module 1130 (shown in FIG. 11A). In some embodiments, communication module 114 may communicate with cyber security module 1130 to perform secure communication with nearby devices and external networks. In one aspect, a secure communication management (SCMT) computer device is provided for providing secure communication. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment, and transmit the converted first data message to the vehicle system using a first communication protocol associated with the vehicle system. According to an embodiment, secure authentication for data transmissions comprises, provisioning a hardware-based security engine (HSE) located in communication systems, said HSE having been manufactured in a secure environment and certified in said secure environment as part of an approved network, performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using a hardware-based security engine including identifying a user device (UD) that incorporates credentials embodied in hardware using a hardware-based module provisioned with one or more security aspects for securing the system, wherein security aspects comprising said hardware-based module communicating with a user of said user device and said HSE.

Referring to FIG. 1, alert signal generation module 116, is an aspect of communication that serves to draw immediate attention to specific events, conditions, or situations that require prompt action or awareness. For example, when the sport mode is selected but the check engine light signal is displayed on the infotainment system, an alert signal may alert the user, or when a user selects warp mode for driving the vehicle, an alert signal regarding putting on the seatbelt is provided to the users of the vehicle. These alert signals are designed to be noticeable, distinctive, and easily recognizable, ensuring they effectively convey the urgency of the situation to the intended recipients. The generation of alert signals takes various forms, depending on the context and the target audience.

In an embodiment, alert signals may be audible alarms. They can range from simple beeps or chimes to attention-grabbing sirens. In an embodiment, it may be a visual alert. Bright and conspicuous visual signals, such as flashing screen, flashing LED displays, flashing text, are employed to draw attention. In addition to auditory and visual alerts, haptic feedback may also be present. Haptic feedback provides alert signals through tactile sensations, such as vibrations or pulses. This form of alert may be used in smartphones and wearable devices to notify users of the messages without relying solely on sound or visuals. In an embodiment, an alert signal may be a text message, an email, app notifications utilized to generate alert signals on electronic devices. In various contexts, alert signals are used to notify drivers of potential issues when driving the vehicle in a selected driving mode.

Referring to FIG. 1, display module 118 may be connected to the alert signal generation module 116 through the vehicle's onboard computer or electronic control unit (ECU) according to an embodiment. The alert signal generation module 116 may further control information displayed on an infotainment system of the vehicle or instrument cluster through the display module 118. The display module 118 may also include algorithms for generating further content and controlling how it is displayed. According to an embodiment, the display module may include a display and a user input. The display may be configured to display a graphical user interface, an image, an icon, and other information. In one embodiment, the display includes a graphical user interface configured to provide general information about the vehicle (e.g., vehicle speed, fuel level, warning lights, etc.). The graphical user interface may also be configured to display a current driving mode of operation, and various potential driving modes of the vehicle. The display module is configured to display the driving mode selection interface on the infotainment system of the vehicle. The system constantly monitors various parameters related to the selected driving mode of the vehicle, a setting applied to a vehicle system, and modification of the vehicle system based on the setting, including sensor data, traffic data, maneuverability of the vehicle, stability of the vehicle, vehicle reaction time, driver reaction time, weather data, and driving patterns. Modern vehicles use Controller Area Network (CAN) or other communication protocols to transmit data between different electronic components and modules, and the display module.

The display module 118 may include one or more buttons, knobs, touchscreens, switches, levers, joysticks, pedals, or handles. In one embodiment, a user may press a button and/or otherwise interface with the user input to change a driving mode of the vehicle. The user may be able to manually control some or all aspects of the operation of the powertrain, and/or other vehicle systems using the display module and the user input. It should be understood that any type of display or input controls may be implemented with the systems and methods described herein.

It would be appreciated by a person ordinarily skilled in the art that system 100 is not restricted to only the components shown in FIG. 1 and may include various other components.

FIG. 2B illustrates a block diagram of various electronic components of the vehicle according to an embodiment.

Referring to FIG. 2B, the vehicle comprising various electronic components, such as, onboard computing platform 202, human-machine interface (HMI) unit 204, communication module 220, sensors 206, electronic control units (ECUs) 208, and vehicle data bus 210 are shown. FIG. 2B illustrates an example architecture of some of the electronic components as shown in FIG. 2A. Onboard computing platform 202 comprises processor 212 (also referred to as a microcontroller unit or a controller) and memory 214. In the illustrated example, processor 212 of the onboard computing platform is structured to comprise a controller 212-1. In other examples, controller 212-1 is incorporated into another ECU with its own processor and memory. The processor may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives), etc. In some examples, memory 214 comprises multiple kinds of memory, particularly volatile memory, and non-volatile memory. Memory 214 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 214, the computer-readable medium, and/or within processor 212 during execution of the instructions.

HMI unit 204 provides an interface between the vehicle and a user. HMI unit 204 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 216 (e.g., a heads-up display, a center console display such as a liquid crystal display (LCD), an organic light emitting diode (OLED) display, a flat panel display, a solid state display, etc.), and/or speaker 218. For example, the display, the speaker, and/or other input and output device(s) of the HMI unit 204 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 216.

Sensors 206 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 206 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system. In an embodiment, the system may initially use certain sensors and identify more sensors to be activated that might be useful in sensing weather conditions, road conditions, or getting access to the required data from the Cloud, etc. In an embodiment, some sensors are active to constantly monitor, and some are activated as needed to reduce the battery power consumption.

Referring to FIG. 2B, ECUs 208 monitor and control the subsystems of the vehicle. For example, ECUs 208 are discrete sets of electronics that comprise their own circuit(s) (e.g., integrated circuits, microprocessors, memory, storage, etc.) and firmware, sensors, actuators, and/or mounting hardware. ECUs 208 communicate and exchange information via vehicle data bus 210. Additionally, the ECUs may communicate properties (e.g., status of the ECUs, sensor readings, control state, errors, and diagnostic codes, etc.) and receive requests from each other. For example, the vehicle may have many ECUs that are positioned in various locations around the vehicle and are communicatively coupled by the vehicle data bus.

In the illustrated example, ECUs 208 comprise autonomy unit 208-1, body control module 208-2, and battery control unit 208-3. For example, autonomy unit 208-1 is operable to perform autonomous and/or semi-autonomous driving maneuvers (e.g., defensive driving maneuvers) of the vehicle based upon, at least in part, instructions received from controller 212-1 and/or data collected by sensors 206 (e.g., object detection sensors 206-1). Further, body control module 208-2 controls one or more subsystems throughout the vehicle, such as power windows, power locks, an immobilizer system, power mirrors, etc. For example, body control module 208-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. A battery control unit 208-3 unit is operable to control the bi-directional on-board charger for charging and discharging the vehicle battery based on signals from the processor.

Referring to FIG. 2B, vehicle data bus 210 communicatively couples communication module 220, onboard computing platform 202, HMI unit 204, sensors 206, and ECUs 208. In some examples, vehicle data bus 210 comprises one or more data buses. Vehicle data bus 210 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

In some embodiments, the vehicle comprises a battery module. The battery module may comprise a battery control unit 208-3 operatively coupled to a vehicle battery and an on-board charger. The battery control unit 208-3 may be operable to control the operation of the on-board charger for charging and discharging the vehicle battery.

Referring to FIG. 2B, communication module 220 may comprise a near field communication module or a communication module for nearby devices 220-1 and far field communication module or communication module for external networks 220-2. Communication module for nearby devices 220-1 is operable to communicate with other nearby communication devices. In an example, communication module 220 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. V2V communications may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 220-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module 220-2 is operable to communicate with external networks. For example, communication module 220-2 comprises hardware (e.g., processors, memory, storage, antenna, etc.) and software to control wired or wireless network interfaces. In the illustrated example, the communication module 220-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 220-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 208-1 of the illustrated example is operable to perform autonomous and/or semi-autonomous driving maneuvers, such as defensive driving maneuvers, for the vehicle. For example, autonomy unit 208-1 performs the autonomous and/or semi-autonomous driving maneuvers based on data collected by sensors 206. In some examples, autonomy unit 208-1 is operable to operate a fully autonomous system, a park-assist system, an advanced driver-assistance system (ADAS), and/or other autonomous system(s) for the vehicle.

An ADAS is configured to assist a driver in safely operating the vehicle. For example, the ADAS is configured to perform adaptive cruise control, collision avoidance, lane-assist (e.g., lane centering), blind-spot detection, rear-collision warning(s), lane departure warnings and/or any other function(s) that assist the driver in operating the vehicle. To perform the driver-assistance features, the ADAS monitors objects (e.g., vehicles, pedestrians, traffic signals, etc.) and develops situational awareness around the vehicle. For example, the ADAS utilizes data collected by the sensors 206, the communication module 220-1 (e.g., from other vehicles, from roadside units, etc.), the communication module 220-2 from a remote server, and/or other sources to monitor the nearby objects and develop situational awareness.

Further, in the illustrated example, controller (or control module) 212-1 is operable to monitor an ambient environment of the vehicle. For example, the controller may detect overheating of the vehicle battery, and take corrective action, such as stopping the battery charging or discharging, in case of overheating, for a certain time period. For example, to enable autonomy unit 208-1 to perform autonomous and/or semi-autonomous driving maneuvers, the controller collects data that is collected by sensors 206 of the vehicle. In some examples, the controller collects location-based data via communication module 220-1 and/or another module (e.g., a GPS receiver) to facilitate the autonomy unit in performing autonomous and/or semi-autonomous driving maneuvers. Additionally, the controller collects data from (i) adjacent vehicle(s) via communication module 220-1 and V2V communication and/or (ii) roadside unit(s) via communication module 220-1 and V2I communication to further facilitate autonomy unit 208-1 in performing autonomous and/or semi-autonomous driving maneuvers.

In operation, according to an embodiment, the communication module 220-1 performs V2V communication with an adjacent vehicle. For example, the communication module 220-1 collects data from the adjacent vehicle that identifies (i) whether the adjacent vehicle includes an autonomous and/or semi-autonomous system (e.g., ADAS), (ii) whether the autonomous and/or semi-autonomous system is active, (iii) whether a manual takeover request of the autonomous and/or semi-autonomous system has been issued, (iv) lane-detection information of the adjacent vehicle, (v) a speed and/or acceleration of the adjacent vehicle, (vi) a (relative) position of the adjacent vehicle, (vii) a direction-of-travel of the adjacent vehicle, (viii) a steering angle rate-of-change of the adjacent vehicle, (ix) dimensions of the adjacent vehicle, (x) whether the adjacent vehicle is utilizing stability control system(s) (e.g., anti-lock braking, traction control, electronic stability control, etc.), and/or any other information that facilitates the controller 212-1 in monitoring the adjacent vehicle.

Based at least partially on the data that the communication module 220-1 collects from the adjacent vehicle via V2V communication, the controller 212-1 can determine a collision probability for the adjacent vehicle. For example, the controller 212-1 determines a collision probability for the adjacent vehicle in response to identifying a manual takeover request within the data collected by the communication module 220-1 for the adjacent vehicle. Additionally, or alternatively, the controller 212-1 determines a collision probability for the adjacent vehicle in response to identifying a discrepancy between (i) lane-marker locations determined by the controller 212-1 of the vehicle based on the sensors 206 and (ii) lane-marker location determined by the adjacent vehicle. Further, in some examples, the controller 212-1 determines the collision probability for the adjacent vehicle based on data collected from other sources, such as the sensors 206, e.g., range detector sensors and/or other sensor(s) of the vehicle, roadside unit(s) in communication with the communication module 220-1 via V2I communication, and/or remote server(s) in communication with the communication module 220-1. For example, the controller 212-1 determines the collision probability for the adjacent vehicle upon determining, based on data collected by the sensors of the vehicle and the adjacent vehicle, that the adjacent vehicle has not detected a nearby object.

In some examples, the controller 212-1 determines the collision probability based on a takeover time for the adjacent vehicle and/or a time-to-collision of the adjacent vehicle. For example, the takeover time corresponds with a duration of time between (1) the adjacent vehicle emitting a request for a manual takeover to be performed and (2) an operator of the adjacent vehicle manually taking over control of the adjacent vehicle. The controller 212-1 is configured to determine the takeover time of the adjacent vehicle based on measured characteristics of the adjacent vehicle (e.g., velocity, acceleration, dimensions, etc.), the operator of the adjacent vehicle (e.g., a measured reaction time, etc.), and/or an environment of the adjacent vehicle (e.g., road conditions, weather conditions, etc.). Further, the time-to-collision corresponds with the time it would take for the adjacent vehicle to collide with another vehicle (e.g., a third vehicle) and/or object (e.g., a guardrail, a highway lane divider, etc.) if the current conditions were maintained.

Additionally, or alternatively, the controller 212-1 is configured to determine the time-to-collision of the adjacent vehicle based on a velocity, an acceleration, a direction-of-travel, a distance to the object, a required steering angle to avoid the object, a steering angle rate-of-change, and/or other measured characteristics of the adjacent vehicle that the communication module 220-1 collects from the adjacent vehicle via V2V communication. Further, the controller 212-1 is configured to determine a collision probability for the vehicle based on the collision probability of the adjacent vehicle.

Upon determining the collision probability of the adjacent vehicle and determining that the collision probability is not as per threshold, the autonomy unit 208-1 autonomously performs (e.g., for the ADAS) a defensive driving maneuver to prevent the vehicle from being involved in a collision caused by the adjacent vehicle. For example, the autonomous defensive driving maneuver includes deceleration, emergency braking, changing of lanes, changing of position within a current lane of travel, etc. In some examples, the autonomy unit 208-1 is configured to initiate the defensive driving maneuver before the takeover time of the adjacent vehicle has been completed. That is, the controller 212-1 is configured to cause the autonomy unit 208-1 to perform the defensive driving maneuver before the operator of the adjacent vehicle manually takes over control of the adjacent vehicle. Further, in some examples, the controller 212-1 emits an audio, visual, haptic, and/or other alert (e.g., via an HMI unit 204) for the operator of the vehicle to request manual takeover in response to determining that the collision probability is above threshold. By emitting such an alert, the controller 212-1 enables the operator of the vehicle to safely take control of the vehicle before the adjacent vehicle is potentially involved in a collision. Additionally, or alternatively, the controller 212-1 is configured to perform other defensive measures (e.g., prefilling brake fluid lines) in response to determining that the collision probability is above threshold.

In an embodiment, a connection is established between a vehicle and the user device. The user device is detected by exchanging handshaking signals. Handshaking is the automated process for negotiation of setting up a communication channel between entities. The processor sends a start signal through the communication channel in order to detect a user device. If the user device receives the signal, the processor may receive an acknowledgement signal from the user device. Upon receiving the acknowledgement signal, the processor establishes a secured connection with the user device. The processor may receive a signal at the communication module from the user device. The processor may further automatically determine the origin of the signal. The processor communicatively connects the communication module to the user device. Then the processor is operable to send and/or receive a message to and/or from the user device. The signals received by the communication module may be analyzed to identify the origin of the signal to determine the location of the user device.

In an embodiment, the system is enabled for bidirectional communication. The system sends a signal and then receives a signal/communication. In an embodiment, the communication could be a permission for access to control the other vehicle. In another embodiment, the communication could be an incremental control communication, for example, an initial control of the speed up to 10 miles per hour, then further additional 10 miles per hour, and so on.

In an embodiment, a data link between the vehicle and nearby vehicle or any other external device is set up in order to permit data to be exchanged between the vehicle and the nearby vehicle or any other external device in the form of a bidirectional communication. This can take place, for example, via a radio link or a data cable. It is therefore possible for the nearby vehicle or any other external device to receive data from the vehicle or for the vehicle to request data from the nearby vehicle or any other external device.

In an embodiment, bidirectional communication comprises the means for data acquisition and is designed to exchange data bidirectionally with one another. In addition, at least the vehicle comprises the logical means for gathering the data and arranging it to a certain protocol based on the receiving entity's protocol.

Initially, a data link for bidirectional communication is set up. The vehicle and the nearby vehicle or any other external device can communicate with one another via this data link and therefore request or exchange data, wherein the data link can be implemented, for example, as a cable link or radio link.

Bidirectional communication has various advantages as described herein. In various embodiments, data is communicated and transferred at a suitable interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional Infrared communication may be used to facilitate the data exchange.

The apparatus for the vehicle according to the embodiment that performs bidirectional communication may be by means of a personal area network (PAN) modem. Therefore, a user can have access to an external device using the vehicle information terminal, and can then store, move, and delete the user's desired data.

The communication module enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G), and Vehicle to everything (V2X) communication systems. The vehicle uses, for example, a message protocol, a message that goes to the other vehicles via a broadcast.

According to an embodiment, the communication module 220 supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Hypertext Transfer Protocol (HTTP), WebSocket, Constrained Application Protocol (CoAP), Diagnostics Over Internet Protocol (DoIP), On-Board Diagnostics (OBD) protocol, and a predefined protocol standard. In an embodiment, communication module 220 may comprise a cyber security module 1130 (shown in FIG. 11A). In some embodiments, communication module 220 may communicate with cyber security module 1130 to perform secure communication with nearby devices and external networks.

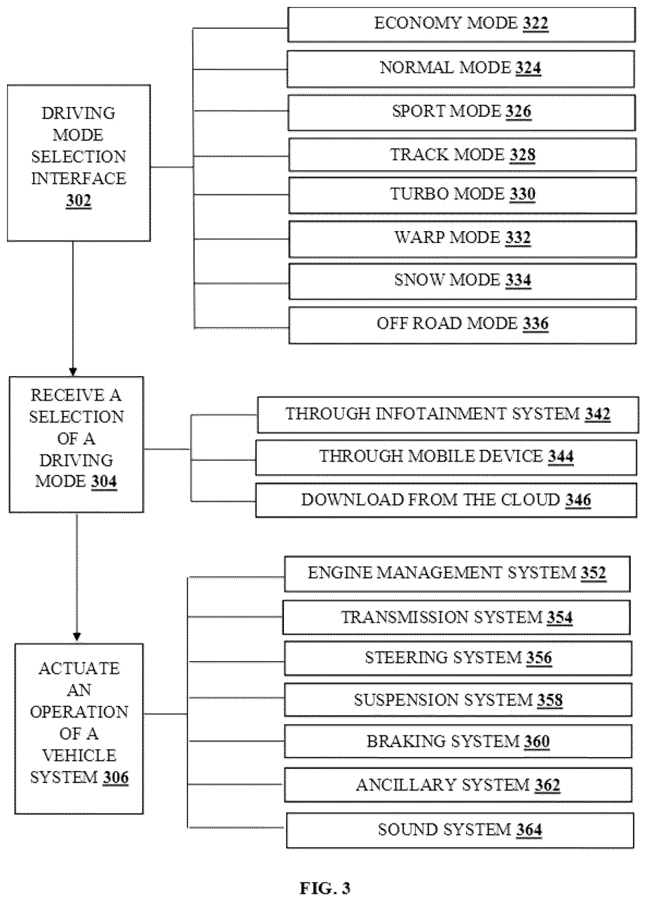

As an example, FIG. 3 illustrates the driving modes available in a vehicle and the vehicle systems that are modified according to one or more embodiments. The driving mode selection interface 302 may display the various driving modes available in the vehicle. Examples of the driving modes may include an economy mode 322, a normal mode 324, a sport mode 326, a track mode 328, a turbo mode 330, a warp mode 332, a snow mode 334, and an off-road mode 336. In an embodiment, the system receives a selection of a driving mode 304 through various alternatives such as through infotainment system 342, through mobile device 344, or downloaded from the cloud 346. The vehicle is then controlled to emulate the performance characteristics, and/or look and feel of the selected driving mode. This may include storing the selected vehicle driving mode in a vehicle memory and controlling the vehicle based on the stored driving mode. The system may actuate an operation of a vehicle system based on an input received to modify a setting of the vehicle system.

Vehicle control by the onboard computing platform 202 and the one or more vehicle controllers, such as controller 212-1, may include controlling the vehicle systems, such as vehicle powertrain, which may include an engine and/or electric machine and transmission to control vehicle acceleration and throttle system through the engine management system as represented at 352, control of a transmission system as represented at 354, control and adjustment of a steering system as represented at 356, control or adjustment of a vehicle suspension system as represented at 358, control and adjustment of a braking system as represented at 360, control or configuration of ancillary systems as represented at 362, and control or simulation of a vehicle sound system as represented at 364. Alternatively, or in combination, the driving mode selection interface and the settings available to the various vehicle systems may be generated based on vehicle specifications such as vehicle acceleration, transmission shift schedules, engine torque, maximum engine RPM, maximum vehicle speed, and the look and feel of vehicle features such as the instrument cluster, for example.

The user may, according to their preference, select a driving mode from a driving mode selection interface. Based on the selected driving mode, one or more vehicle systems may be modified by the user. In an embodiment, the vehicle systems that may be modified for the selected driving mode may be displayed on the infotainment system of the vehicle. The user may then select a particular vehicle system, which may display the plurality of settings available for modification to the operation of the vehicle system. In an embodiment, the driving mode selection interface may be provided via buttons on the steering wheel or center console, the infotainment touchscreen, by using an application for the driving mode selection interface on a mobile device or downloaded from the cloud and accessible via the infotainment touchscreen of the vehicle. The selection of a driving mode and the modifications to the settings of the vehicle systems are communicated to the vehicle's computing platform 202 and the ECU 208 to change the operation of the vehicle system according to the modified settings. For example, changing the driving mode allows for a different fueling and ignition timing map in the ECU, a different boost map in the ECU, modification to the automatic transmission shift schedule algorithm, and a different gearshift pattern in the gearbox ECU if the vehicle has automatic transmission. Driving modes allow for the settings of the one or more vehicle systems to be tailored to match a driver's mood. The various parameters for a mode change may be implemented in the design phase of the vehicle. Driving modes are control modes of at least one vehicle system, and the ECU may be configured to initiate control of the one or more vehicle systems, each of which corresponds to one or more different driving conditions for the vehicle. For example, the system provides an acceleration characteristic range and a transmission ratio characteristic of the automatic transmission based on the accelerator opening and the traveling speed. Further, the carburetor may be tuned so that for the same throttle opening, either less or more gasoline would be sucked in and sprayed, depending on a setting to the vehicle system based on the occupant preference. Further, vehicles may use programmed fuel injection which uses microprocessors, replacing the mechanical equipment called carburetor. Here, the vehicle engine remains the same, the upper and lower limits to the amount of gasoline are adjusted to inject in an engine. Further, the overall maximum values of torque and brake horsepower (bhp) may remain the same, and the way each are delivered may differ in different modes. Further, when the vehicle is in an autonomous driving mode, the machine learning models communicate instructions to the ECU/s to simultaneously activate the driving mode based on learning.

In some embodiments, the vehicle may comprise one or more driving modes such as an economy mode, a normal mode, a sport mode, a track mode, a turbo mode, a warp mode, a snow mode, and an off road mode.

Eco Mode or economy mode 322: According to an embodiment, this mode may be an environmentally conscious mode wherein the focus is not on delivering performance, but on efficiency. In an embodiment, the vehicle systems that may be available for modification in this mode may include the throttle system, transmission system, and the climate control system. The settings of the throttle system may be modified to make it less responsive to the pedal controller, and the settings to the transmission system may be modified to keep it at minimum fuel usage setting to get the maximum mileage, and so that the engine uses less acceleration, so as to save on fuel. The climate control system may be modified to maintain the temperature inside the vehicle at an optimal setting so as to put less strain on the engine.

Normal mode or comfort mode 324: According to an embodiment, this may be the routine driving mode that aims for balance by delivering better performance than Eco mode, but also not too far away as it still offers conservation. In this mode the settings to the suspension system may be modified so that the operation of the suspension system may be towards the softer and more relaxed side, so as to improve passenger comfort, and throttle system response may be strong enough to engage the driver without becoming harsh or aggressive. In an embodiment, the settings to the steering system may be such that the steering system is relaxed. In this driving mode the occupant of the vehicle may not want the vehicle's exhaust to be loud, like it would be in a Sport mode, so the ability to switch into ‘Comfort’ mode or ‘Normal’ mode, or modify the settings of the vehicle system, typically puts the vehicle in a passive setting. In an example, if the vehicle has a large 6-cylinder engine, it may shut down cylinders to save fuel, along with shutting exhaust valves for a quieter and more relaxing drive at a preset speed. The speed may be preset by the user through the driving mode selection interface or automatically selected by the vehicle based on the driving mode.

Sport Mode 326: According to an embodiment, sport mode may be referred to as dynamic mode or turbo mode. In sport mode the user/occupant may modify the setting of the suspension system to make it stiffer/harder and the setting to the steering system may be modified to increase the steering weight. The setting to the engine system may make the engine rev higher, and the throttle system become more responsive. The transmission system may be modified to maintain a higher throttle response from the engine. The settings to the sound system may be modified to make a louder interior sound and a louder exhaust sound. This mode may be modified for the driver to have an engaging driving experience. In another example, if the occupant of the vehicle wants more volume, modification to the sound system may include opening exhaust valves, and the like, for a more thrilling drive.

Super sports mode or Sport+/Track Mode 328: According to an embodiment, in this driving mode the vehicle systems may be modified so as to provide an even more thrilling experience than the sport mode. The setting to the throttle system may be modified for a stronger acceleration and the best handling the vehicle can deliver. It is similar to the sport mode, but with more emphasis on performance, acceleration including torque and throttle response, top speed including horsepower, more responsive steering/turning system and braking system, and hard/stiffer suspension system. The vehicle may employ active bolstering, which may tighten to hold the occupant in place during high speed cornering. In this mode the traction control systems of the vehicle may be modified to reduce vehicle sideways motion during aggressive track driving.

Turbo mode 330: According to an embodiment, in this driving mode the vehicle systems may be modified by pushing more air into the engine, with a greater amount of fuel injected, thereby increasing the strength of combustion, and producing more power. A turbo engine in vehicles with an internal combustion engine may be fitted with a turbocharger device. The turbocharger gives the engine extra power without sacrificing on fuel efficiency. The turbocharger may give the vehicle extra power without increasing the size of the engine. Further, a turbo engine may also increase torque, especially at low revs.

Warp mode 332: According to an embodiment, warp mode may alter the operation of several vehicle systems. In an embodiment, in warp mode, the setting of the throttle system may be modified so that the gain/response of the pedal controller may be increased such that the engine is more responsive to throttle input. Further, the modifications to the setting of the transmission system may include modifications to the automatic transmission shift schedule algorithm so that the vehicle runs in lower gears/settings, increasing provided power/torque at the cost of fuel economy. In warp mode, the settings of the suspension system may be modified so that the stiffness of the suspension of the vehicle may be increased (e.g., via selectable settings of the struts, shocks, and/or via inflatable suspension bags). The modification to the settings of the braking system may include an increase in the brake response of the vehicle. Also, modification to the settings of the steering system and drive system may include an increase in the turning response of the vehicle. More of the engine power may be provided to the drivetrain, and reduced power may be provided to ancillary systems that are generally not desired/required while the vehicle is driving in warp mode. Further, warp mode may alter the sound file/profile of interior or exterior sound production for vehicles, such as for electric vehicles, changes in decibel (db) sound production output of the interior/exterior sound production or the balance between the interior and exterior sound of the vehicle. Generally, exterior and/or interior safety noise production may be increased while in warp mode. For example, warp mode may cause the vehicle to produce fake squealing tire sounds when accelerating from a stopped position and/or when heavily accelerating. In a setting, the vehicle opens or closes flaps and wings in order to improve aerodynamic efficiency. In warp mode, the power steering motor/engine sensitivity may also be changed. This may be done with an electric power steering. For the 4-wheel drive or all-wheel drive settings, the engine system controls the torque distribution through the differentials (in addition to other parameters like selective braking for better traction). Further in warp mode, non-critical warning systems, alert systems, etc., may be silenced, run in the background, disengaged, or put on standby. For instance, warp mode may only allow for the operation of the check engine light, low fuel warnings, engine/coolant high temperature warnings, seatbelt alarms, etc. Generally, warp mode allows the operator/user to enjoy an exhilarating ride without the annoyance and distraction of non-critical vehicle warnings, alerts, and the like. For example, alerts and warnings related to wheel alignment monitoring systems, tire rotation/wear monitoring systems, etc., may be hidden or not provided while in warp mode. In response to warp mode being disengaged, one or more reports may be generated indicating warnings, alerts, and the like from vehicle monitoring systems silenced during the warp mode session.

Snow Mode 334: This mode may be used for driving in winter weather conditions including snow and ice and designed to optimize traction. In this mode modifications may be made to the throttle system so that the vehicle starts with less power and torque to help prevent skidding. Further, modifications may be made to the settings of the transmission system to keep the engine speed down. In snow, this mode may keep the vehicle wheels from spinning and improve traction.

Off-Road Mode 336: The vehicle system modifications in this mode may be similar to the modifications made in snow mode. The settings to the vehicle systems may be modified to improve traction when the surface beneath the vehicle tires is off the road, such as on mud, sand, rocks, etc. The vehicle system may be modified for downhill assist control wherein traction control systems are used with anti-lock brakes, by making modifications to the braking pressure to help control slippage and maintain a constant preset speed while going down a steep grade. Further, the settings of the suspension system may be modified to raise the vehicle for better ground clearance. In an embodiment, the ECU detects the wheel grip according to the terrain and supplies power accordingly. Grip level may differ in mud/slush, snow, sand, rocks, etc. In the off-road mode, the vehicle systems that may be modified to include the throttle system, the automatic transmission system, and the braking system, and the modifications are to increase a rough terrain handling ability of the vehicle. In an embodiment, in the off-road mode, the target acceleration is reduced when stepping on the accelerator pedal, the braking force is increased when stepping on the brake pedal, the driving torque of the engine is reduced in the early stage of turning, an idle engine speed is increased, and the torque distribution to the rear wheels may be increased.

The settings modified for each driving mode are exemplary. The user of the vehicle may, according to their preference, alter/modify the default settings of one or more vehicle systems for any of the driving modes. The modifications may be within the threshold range that is available for modifications to a vehicle system. For example, if the maximum acceleration available in sport mode is 100 mph, the threshold range for acceleration may have a maximum value of 100 mph.

Examples of vehicle systems wherein the operation of the vehicle system may be altered may include one or more of the following:

Engine management system 352 or throttle response or engine system may refer to any input that modulates the power output of a vehicle's engine or motor. For example, it is a measure of how quickly a vehicle's internal combustion engine can increase its power output in response to a driver's request for acceleration. The throttle response may be altered to be more or less sensitive. Engine management system is used for the changes in engine performance of a vehicle. In an embodiment, the engine control unit (ECU) 208 may inform the throttle system to pump more fuel/air into the engine when the setting to the vehicle system requires higher power performance or more throttle response. More fuel being burned in the engine means increased power. In a mode with increased throttle output, there is an increase in rev limit, where the vehicle holds onto a gear longer in case of automatic and automated manual transmission, the ignition timing is altered, and there is reduction in exhaust back-pressure. The throttle response may be tuned to be more sensitive, wherein small inputs on the accelerator pedal may produce a quicker response from the engine. The ECU might change fuel mapping and ignition timing for more power and responsiveness. In an embodiment, the ECU may operate the electromechanical transmission using the energy stored in an energy storage device to drive the front axle or the rear axle of the vehicle.

A transmission system 354, also referred to as a gearbox, is a mechanical device which uses a gear set, two or more gears working together to change the speed, direction of rotation, or torque multiplication/reduction in a vehicle. Vehicles with internal combustion engines require the engine to operate in a narrow range of rates of rotation, requiring a gearbox, operated manually or automatically, to drive the wheels over a wide range of speeds. The gearbox/transmission sharpness may be altered to be fast or slow. The transmission system allows for acceleration to reach high levels before shifting up a gear while driving in automatic transmission in a driving mode that requires more performance of the transmission system. The high rev mode means higher power and torque being applied by the engine to the wheels. Automatic transmissions may change shift points, the point either in engine revolutions per minute (RPM) or speed, at which the transmission may shift to the next gear, to hold gears longer, allowing the engine to operate at higher RPMs for more power. The transmission may also downshift more readily, improving acceleration when the driver presses the accelerator.

Vehicle suspension 358 is the system of tires, tire air, springs, shock absorbers, and links that connect a vehicle to its wheels and allows relative motion between the two. Suspension helps ensure that the drive is safe and smooth by absorbing the energy from various road bumps and other dynamic impacts, such as vibrations. The suspension system may allow for alterations to the suspension settings, and the settings may range from soft to stiff suspension. Soft suspension provides for a smooth ride by absorbing the irregularities in the road. The stiffness of the suspension allows to reduce body roll or rollover during cornering, thus improving handling. According to the driving mode selected, the occupant may alter the setting of the suspension system. In an embodiment the suspension may be loose on the front part of the vehicle and tighter on the back part of the vehicle. In an embodiment, the ECU may adjust the suspension height level and lower the vehicle nearer to the ground or raise the vehicle for more ground clearance. Ground clearance may alter the vehicle height for performance or ease of use. A lower suspension increases the handling capabilities of the vehicle. A vehicle that sits lower on the road produces more downward force. This increases the cornering capabilities of the vehicle and also hardens the feel of the suspension or tightens/stiffens the suspension. The vehicle may have coil spring spacers, adjustable coilovers, anti-roll bars or sway bars to modify the suspension of the vehicle or utilize the suspension system of the vehicle to modify the ground clearance of the vehicle. The suspension system may be designed with the combination of design variables and operation parameters to provide optimum vibration performance.

The steering system or the turning system 356 allows for changes to the steering of the vehicle. The steering system may be modified to be sharper wherein the driver has more control over the steering of the vehicle. Traction and stability control may allow the adjustment of the traction and stability control systems to allow for more wheel slip, which can be beneficial for spirited driving or in certain high speed driving conditions. The vehicle may include steering wheel adjustments wherein the height of the steering wheel may be increased and the steering wheel is closer to the driver, or the steering wheel may be pulled out towards the driver, and the driver may make modifications based on their requirements. The vehicle may include power steering which helps the driver of a vehicle to steer by directing some of its engine power to assist in swiveling the steered road wheels about their steering axes. The vehicle may include speed-sensitive steering which allows for highly assisted steering at low speeds for maneuverability, and lightly assisted steering at high speeds for stability. Four-wheel steering may be employed by the vehicle to improve steering response, increase vehicle stability while maneuvering at high speed, or to decrease turning radius at low speed.

The purpose of the braking system 360 is to slow down or halt a moving vehicle by generating frictional force between the shoe and the wheel drum or disc and convert the vehicle's kinetic energy into thermal energy. It contains several parts, including brake pads, brake rotors, calipers, and brake fluid. The brake system prevents the wheel from turning or turning by using the friction between the non-rotating elements connected to the body and the rotating elements connected to the wheel (or transmission shaft). There are various braking systems including mechanical, hydraulic, and anti-lock brake systems (ABS), each with different degrees of efficiency. ABS operates by preventing the wheels from locking up during braking, thereby maintaining traction contact with the road surface and allowing the driver to maintain more control over the vehicle. The ECU constantly monitors the rotational speed of each wheel, if it detects the wheel rotating significantly slower than the speed of the vehicle, a condition indicative of impending wheel lock, it actuates the valves to reduce hydraulic pressure to the brake at the affected wheel, thus reducing the braking force on that wheel, and the wheel then turns faster. Conversely, if the ECU detects a wheel turning significantly faster than the others, brake hydraulic pressure to the wheel is increased so the braking force is reapplied, slowing down the wheel.

The braking system for a driving mode with high speeds needs to bring the vehicle to slower speeds without any adverse effects. The brakes for vehicles with higher speed driving modes may include brake pads and are built to work under high temperatures. In an embodiment, the braking system may include multiple-piston brake calipers, aggressive compounds for brake pads, larger rotors, construction such as two-piece rotors or carbon fiber construction, more track-oriented brake fluid, and stainless steel braided brake lines, to increase stopping power and reduce resistance. Some rotors may be slotted or drilled as well to help rotor cooling and to shave pad surfaces.

An ancillary system 362 may include non-critical warning systems, such as vehicle monitoring systems, wheel alignment monitoring systems, tire rotation/wear monitoring systems, etc. Ancillary systems may further include air conditioning, air vents, heater, interior lighting, sound systems, sunroof, windscreen wipers, head restraint adjustment, instrument panel, GPS systems. The driver/occupant of the vehicle may choose to modify an ancillary system according to the driving mode selected. In a high speed mode, such as sport mode or warp mode, where the driver does not want to be disturbed, the non-critical warnings and alerts may be silenced, run in the background, disengaged, or put in standby. In response to such modes being disengaged, one or more reports may be generated indicating warnings, alerts, and the like from vehicle monitoring systems silenced during the driving session.

The sound system 364 of the vehicle may be modified to alter the sound file interior of the vehicle or exterior to the vehicle. Various embodiments of the disclosure include a sound system, and the ECU may control the vehicle sound system to broadcast actual engine sounds or user selected sounds through the speaker(s) based on current vehicle operating parameters or conditions, such as an accelerator pedal position, vehicle speed, and/or transmission or simulated gear, for example. User selected sounds may be to emulate a characteristic or iconic sound, such as fake squealing tire sounds when accelerating from a stopped position and/or when heavily accelerating. In an embodiment, the user selected sounds may be either downloaded by the user based on their preference or chosen from a list of sounds already available in the vehicle memory. Some vehicles may enhance the engine sound through the sound system or open valves in the exhaust or wire in engine-enhancing speakers.

The range for the modification to a setting of a vehicle system ranges from the minimum value of setting of a vehicle system to the maximum value of setting of the vehicle system available in the vehicle. Further, once a driving mode is selected, a range is provided for modifications to the settings of the one or more vehicle systems based on the selected driving mode.

For example, the range for modification to the suspension system may be different for the normal mode and warp mode. Once a value is selected for a first vehicle system, the threshold ranges for modification to the settings of other vehicle systems may be varied based on the degree of modification to the first vehicle system. For example, if the driving mode selected is the track mode, the acceleration may reach the maximum available setting, and the transmission system, the steering system, and the braking system may be accordingly modified. In another example, if the driving mode selected is the warp mode, and the setting to the throttle system is modified towards the higher end of the setting available in the vehicle, the available threshold range for modification to the setting of the suspension may also range from stiff suspension to the stiffest suspension available in the vehicle. The driving mode selection interface may allow the user to modify a driving mode based on their preference. The present disclosure provides for safety metrics ensuring that the selections and modifications to the vehicle systems are within the safety parameter for safe driving experience for the user of the vehicle.

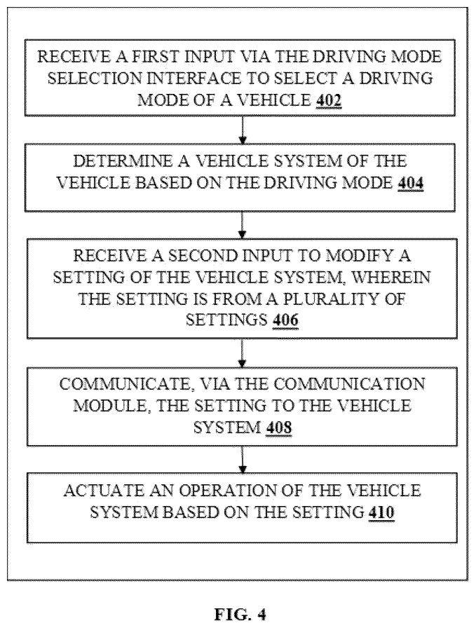

FIG. 4 illustrates a flow chart describing a method for selection of a driving mode of a vehicle.

In some embodiments, the method shown in FIG. 4 may be carried out by a processor using instructions stored in a memory that, when executed, cause the processor to carry out the method. In an embodiment, the method as shown in FIG. 4 may be performed by system 100 as shown in FIG. 1.

Referring to FIG. 4, the method may, at step 402, receive a first input via the driving mode selection interface to select a driving mode of a vehicle. The method may, at step 404, determine a vehicle system of the vehicle based on the driving mode. The method may, at step 406, receive a second input to modify a setting of the vehicle system, wherein the setting is from a plurality of settings. The method may, at step 408, communicate, via the communication module, the setting to the vehicle system. The method may, at step 410, actuate an operation of the vehicle system based on the setting.

In an embodiment, the method may further comprise displaying selectable driving modes on a display screen. In an embodiment, the driving mode selection interface may allow an occupant of the vehicle to select one of the driving modes from the display screen. In an embodiment, the display screen may be a screen of one of an infotainment system of the vehicle, and an application on a mobile device.

In an embodiment, the driving mode may comprise one of an economy mode, a normal mode, a sport mode, a track mode, a turbo mode, a warp mode, a snow mode, and an off-road mode. In an embodiment, the vehicle system may comprise one of an engine management system, a transmission system, a steering system, a throttle system, an automatic transmission system, a suspension system, a braking system, an ancillary system, and a sound system. In an embodiment, the method may further comprise selectively operating a powertrain of the vehicle in a plurality of driving modes.

According to an embodiment, the vehicle may include a computing platform such as the onboard computing platform in FIG. 2B. The computing platform may include one or more processors configured to perform instructions, commands, and other routines in support of the processes, functions, or algorithms described herein. For example, the computing platform may be configured to execute instructions of vehicle applications to provide features such as navigation, data processing, and wireless communications. The computing platform may receive a vehicle driving mode selection from the infotainment system or downloaded from the cloud or received from a mobile device. Such instructions and other data may be maintained in a non-volatile manner using a variety of types of computer-readable storage mediums.

According to an embodiment, the computing platform may be provided with various features allowing the vehicle occupant/user to interface with the computing platform. For example, the computing platform may receive user input, a command, a request, etc. From human-machine interface (HMI) controls configured to provide for occupant interaction with the vehicle. As an example, the computing platform may interface with one or more software or hardware buttons or other HMI controls configured to invoke functions on the computing platform (e.g., instrument panel controls, steering wheel audio buttons, a push-to-talk button, etc.). Similarly, HMI may include one or more video screens or displays to present information from various vehicle sensors and vehicle systems to the driver/occupant, such as vehicle speed, outside temperature, cooling system temperature, etc. In one or more embodiments, HMI is configured to display the driving mode selection interface.

According to an embodiment, the computing platform may also drive or otherwise communicate with one or more displays configured to provide visual output to vehicle occupants by way of a video controller or HMI. In an example, the display may be a touch screen further configured to receive user touch input via the video controller, while in other cases the display may be a display only, without touch input capabilities, and may be used to display an instrument cluster of analog and/or digital devices corresponding to the selected vehicle systems, for example. The computing platform may also drive or otherwise communicate with a vehicle sound system including one or more speakers configured to provide audio output to vehicle occupants by way of an audio controller. The computing platform may read various signals from the driving mode selection interface.

The controller may accept signals inputted from a range sensor which detects a range of a shift lever, an engine speed sensor which detects an engine speed of the engine, a vehicle speed sensor which detects a vehicle speed, an acceleration sensor which detects an acceleration of the vehicle, a steering angle sensor which detects a steering angle of the vehicle, a fuel sensor which detects the residual quantity of fuel, a water temperature sensor which detects a temperature of the engine cooling water or coolant, an accelerator opening sensor which detects a stepping-on amount of an accelerator pedal, a braking pressure sensor which detects a braking pressure generated inside the master cylinder according to the stepping-on amount of the brake pedal, etc.

In an embodiment, the computing platform may be configured to wirelessly communicate with a mobile device of the vehicle user or the vehicle occupant via a wireless connection through a wireless transceiver. The mobile device may be any of various types of portable computing device, such as cellular phones, tablet computers, smart watches, laptop computers, portable music players, or other devices having a processor coupled to a memory and configured for communication with the computing platform of the vehicle to communicate a selected driving mode to the vehicle. Mobile devices may obtain a preset driving mode for the vehicle from one or more computer servers in the cloud for download. Alternatively, the vehicle computing platform may wirelessly receive a selected driving mode directly from the cloud. The wireless transceiver may be in communication with a Wi-Fi controller, a Bluetooth controller, a radio-frequency identification (RFID) controller, a near-field communication (NEC) controller, and other such controllers such as a Zigbee transceiver, an IrDA transceiver, and configured to communicate with a compatible wireless transceiver of the mobile device.

The ECU further includes a body control module (BCM) configured to monitor and control chassis or body operations of the vehicle. For example, the BCM may be configured to control and monitor vehicle body functions such as door lock/unlock, vehicle occupancy, blind spot monitoring or the like using signals detected via one or more sensors as mentioned in FIG. 2B. Similarly, configurations for the BCM may be stored as BCM configuration data in the BCM. In an embodiment, the vehicle may include an adjustable or active suspension system or computer ride control. An active suspension system may include adjustable shock absorbers or springs with an actuator or servo controlled by the BCM based on a received vehicle driving mode. As such, the selected vehicle driving mode may be used to control or adjust the active suspension system to modify its character by adjusting shock stiffness, spring rate, ride height, etc. to modify ride performance, drivability and responsiveness based on the selected driving mode so that the occupant may enjoy the ride based on their selected preferences.

In an embodiment, the method may further comprise providing a first threshold range for modification to a setting of a first vehicle system. The first threshold range may range from the minimum to the maximum setting available for the vehicle system. In an embodiment, the system may further comprise determining a second threshold range for modification to a setting of a second vehicle system based on the modification to the setting of the first vehicle system. The ECU may determine that for a setting selected for the first vehicle system, the available threshold range for another vehicle system may not be the complete threshold range available for that vehicle system.

For at least those reasons described above, and also described below, the ability of the controller of the computing platform to adjust threshold values and ranges for modifications to vehicle systems range from the settings available for each of the vehicle systems for a particular driving mode. The setting to a vehicle system may be based at least on the operating conditions, the state of health of a battery pack, if any, and/or modifications available to the vehicle settings which may be advantageous in ensuring that the vehicle maintains operational readiness for the various driving modes. By adjusting threshold values, the controller can ensure that the multiple vehicle settings provide for safe operation of the vehicle.

In an embodiment, the method may further comprise initiating the driving mode in response to a user input to initiate the driving mode or automatically based on an environmental condition. For example, the user may be driving through a high speed limit area and select the sport mode of the vehicle for high speed driving, however a car might have broken down further down on the road, and in that case the ECU of the vehicle may automatically transition the vehicle from sport mode to the normal mode by communicating the settings for the normal mode to the various vehicle systems when it determines from the sensors that there is a blockage on the road. In an embodiment, the method may further comprise automatically transitioning the vehicle from one driving mode to another driving mode based on one of a terrain change and past driving history over a route. In an embodiment, the method may further comprise temporarily transitioning the vehicle from one driving mode to another driving mode based on one of a terrain change and past driving history over a route. For example, the vehicle may drive through a specific route on a particular weekday and time of day. In this case, the onboard computing platform processes the past driving history of the vehicle and predicts that the vehicle is driven in the warp mode over the section of the route and the ECU may temporarily transition the vehicle to warp mode when the vehicle drives through the specific route on the particular weekday and time of day. In an embodiment, the method may further comprise defining a user specific driving mode, based on training data related to user usage characteristics of the vehicle system.

In an embodiment, the driving mode of the vehicle may automatically and/or temporarily transition the vehicle (or the setting of certain vehicle systems) from warp mode to a lower operational mode if certain terrains are encountered or when the vehicle is traveling over a portion of the route previously identified as unsuitable for full warp mode operation, e.g., the stiffness of the suspension may be temporarily reduced when traveling over train tracks, known pot holes, etc.

In some embodiments, the controller is selectively actuatable between the automatic and the manual mode. For example, the controller can receive a user input from the user interface, human machine interface, etc. that the powertrain should be automatically transitioned between different modes of operation based on the driving mode. When the controller is in the automatic/autonomous mode, the controller automatically transitions the powertrain into a driving mode without requiring user inputs (e.g., in response to the traffic conditions, weather conditions, road conditions, etc.). When the controller is in the manual mode, the controller transitions the powertrain from one driving mode to another driving mode in response to receiving a user input from the user interface. The transition from one driving mode to another may be further based on factors such as the vehicle has travelled a predetermined distance, is outside of a geofence, reached a certain speed, reached a certain location, been driven for a period of time, etc.

In an embodiment, the method may further comprise determining that the modifications to the one or more vehicle systems conform to safety metrics related to the vehicle systems. The safety metrics may define the operational parameters for the optimal working of the vehicle systems. In an embodiment, the method may further comprise calculating statistical data on an impact of the modification to the vehicle system. In an embodiment, the statistical data is displayed on the infotainment system and/or mobile device of the user. Statistical data helps understand the machine error, human error, and the wear and tear of the vehicle systems and the points and settings where the system operates best. Statistical data may be used as training data by the computing platform to calculate the optimal settings of the vehicle systems. In an embodiment, the method may further comprise automatically suggesting modifications to the settings of the one or more vehicle systems. The computing platform may provide suggestions to the user of the vehicle based on the driving mode selected. The suggestions may be based on historical user usage data of the driving modes. In an embodiment, the method may further comprise downloading the setting to a vehicle system based on a particular driving mode preset by a user.

In an embodiment, the method may further comprise modifying vehicle warnings based on the selected driving mode. In an embodiment, the method may further comprise controlling a sound profile of the vehicle in response to a vehicle accelerator pedal position. In an embodiment, the sound profile is one of interior of the vehicle, and exterior of the vehicle.

In an embodiment, the method may further comprise determining a safe driving speed of the vehicle based on one of a road condition of a road, an environmental factor of an environment, a traffic condition, vehicle proximity, and other vehicles on the road. The computing platform may gather the data from the ECU and based on the data determine a driving speed safe for the section of the route. In an embodiment, the environmental factor may comprise at least one aspect related to the environment comprising an element in the environment, the element comprising one of a natural obstacle, a building, a weather phenomenon, a pathway characteristic, a pedestrian, and a cyclist. The ECU may gather data on the environmental factors and provide the data to the computing platform to determine a safe driving mode for the vehicle. In an embodiment, the method may further comprise running non-critical warnings of the vehicle in a background mode when the driving mode selected is warp mode, for example. In an embodiment, the non-critical warnings may comprise a warning related to one of a monitoring system, an incoming phone call, and a sensor. In an embodiment, the method may further comprise maintaining a log indicating the non-critical warnings run in the background mode. The log of the non-critical warnings may be displayed on the infotainment system of the vehicle for user reference when the warp mode driving session of the user finishes or the driving mode is changed to normal mode, for example.

In an embodiment, the vehicle is one of an electric vehicle, a gas controlled vehicle, a hybrid vehicle, and an autonomous vehicle. In an embodiment, the method may further comprise a mobile device having a device processor and a device memory, wherein the device memory stores driving mode details of the vehicle and wherein the processor is configured to wirelessly transfer the driving mode details to the vehicle. The driving mode details may include the settings to the multiple vehicle systems in the various driving modes.

In an embodiment, the method may further comprise a user profile data configured to control one or more operations of the vehicle driving mode and the vehicle systems when the vehicle is in an autonomous mode. The user profile data may include user specific details for settings to the vehicle systems for one or more driving modes of the vehicle. In an embodiment, the method may further comprise engaging the vehicle in an autonomous mode along with another driving mode, such as when the vehicle is driving in an autonomous mode the user may simultaneously engage the sport mode of the vehicle. In an embodiment, when the driving mode selected is an autonomous driving mode, an artificial intelligence (AI) unit of the vehicle is configured to determine suitable sections of a route for driving the vehicle simultaneously in the autonomous driving mode and a driving mode with fast speed. In an embodiment, the method may further comprise, in a state in which the vehicle is travelling in an autonomous driving mode, determining whether the second input received to modify the setting of the vehicle system is suitable to be applied along with the autonomous driving mode. For example, when the vehicle is driving in an autonomous mode, the settings to vehicle systems such as throttle response, suspension system, steering system, etc. may be defined according to autonomous driving mode. When a driving mode such as warp mode is selected by the user when the vehicle is driving in autonomous mode, the computing platform ensures that the setting to the throttle system or the suspension system as per the warp mode can be applied when the vehicle is driving in autonomous mode, and if the setting is suitable to be applied the processor applies the settings to the vehicle systems. In an embodiment, the method may further comprise, in a state in which the vehicle is travelling in an autonomous driving mode, generating a customized transition plan for one or more vehicle systems for transitioning between the autonomous driving mode and the autonomous driving mode combined with the driving mode with fast speed according to one or more identified circumstantial factors. The one or more identified circumstantial factors may include road conditions, a level of traffic congestion within a selected distance from the vehicle, weather conditions, and autonomous vehicle manufacturer conditions. In an embodiment, the method may further comprise implementing a machine learning mechanism, such as Convolutional Neural Networks (CNNs), to learn the one or more identified circumstantial factors and the customized transition plan for the one or more vehicle systems, and minimum and maximum transition periods required for each of the one or more vehicle systems.

In an embodiment, the method may further comprise one or more machine learning models aided by artificial intelligence. In an embodiment, the machine learning models are trained on the first input and the second input. In an embodiment, the machine learning models are configured to predict based on the first input and the second input, an optimized setting to a vehicle system for a selected driving mode. In an embodiment, the machine learning models are trained on historical data comprising user preference data, route data, one or more of vehicle parameters, and occupant prior travel history data. In an embodiment, the machine learning models are configured to continuously learn, and update as new data is collected, improving the accuracy of modifications of the vehicle systems in a particular driving mode over time through adaptive algorithms. In an embodiment, regression algorithm models, such as Bayesian regression, neural network regression and decision forest regression, may be used for prediction, classification models such as support vector machines (SVM) and K nearest neighbor (KNN) may be used for classification, and decision making algorithm models such as gradient boosting (GDM) and Adaptive Boosting.

According to an embodiment, driving mode of the vehicle may be simultaneously engaged with an autonomous mode of the vehicle. For example, a warp mode of the vehicle may be selected and activated while the vehicle is driving in an autonomous mode. In an embodiment, the autonomous vehicle may simultaneously engage with a driving mode based on detected or received information about other vehicles and/or their actions. In another embodiment, the autonomous vehicle may engage with a driving mode based on detected or received information about the environment, topological constraints associated with the environment, as well as other vehicles and/or their actions.

In an embodiment, during the modification of a setting of a vehicle system and/or during a transition between two or more settings associated with a selected driving mode, the autonomous vehicle may continually detect or receive information about other vehicles and/or the environment. During such transition stages, the autonomous vehicle may continue to update its selection of a setting of a vehicle system based on the detected or received information. For example, if an autonomous vehicle has a particular threshold topological number at or above which it seeks to operate, the autonomous vehicle may select a setting of a vehicle system from the available set of settings based on the detected or determined topological constraints, as well as predicted topological constraints, in order to maintain its operation within the environment at or above the threshold topological number.

The aspects of the environment may include elements in the environment such as road signs, traffic signals, pedestrians, cyclists, animals, trees, buildings, obstructions, natural or artificial obstacles, human-operated vehicles, disabled or malfunctioning vehicles, dynamic environmental conditions such as wind/gusts, rain, snow, ice, or pressure, or other elements. The topological constraints may include roadway or pathway characteristics or conditions, weather associated with the environment, or characteristics or capabilities of the vehicles. In addition, the topological constraints may be determined based at least in part on the aspects of the environment. The aspects of the environment and the topological constraints may be used to determine or filter the set of available settings of the vehicle systems associated with a selected driving mode. The vehicle, while engaged in autonomous mode may also determine or receive one or more operational goals for the system as a whole. The operational goals may include one or more of safety, resolvability, efficiency, time, priority, throughput, on-time completion, average speed, number of incidents or conflicts, fuel or resource utilization, and/or other goals. The autonomous vehicle may consider traffic conditions such as traffic density, vehicle proximity, traffic light status, lane occupancy, road closures, and alternate route suggestions, travel path information such as anticipated turns, road curvature, elevation changes, path signs, road surface conditions, and obstacles information such as stationary objects, moving vehicles, pedestrians, road infrastructure, and road hazards detected within an area around the vehicle. The autonomous vehicle may then process all the information received from the other vehicles and the environment, while also taking into account the operational goals for the system.

For example, when warp mode is engaged simultaneously with an autonomous driving system/mode, AI of the autonomous driving system may be trained/configured to determine suitable sections of the route where fast/aggressive driving is relatively “safe” as compared to the other driving conditions such as rush hour, near school driving, normal speed limits, etc. For example, when traveling on Texas State Highway 130 with a speed limit of 85 mph or sections of the Autobahn with similar high speed limits or no speed limits, the AI may determine a maximum “safe” speed based on the current driving conditions. In warp mode, the AI/autonomous driving system may operate the vehicle up to the maximum “safe” speed and/or applicable speed limit, whichever is lower. The system may make this determination for each section of the route, allowing high speeds and up to maximum acceleration at open portions of a high speed road, and reduced speeds/acceleration when conditions necessitate, e.g., road congestion, wet/slippery roads, reduced visibility, etc. Thus, the combination of the engaged autonomous driving system/mode and the warp mode may allow the vehicle to reach the destination as fast and safely as possible, with reduced, minimal, or no occupant effort required. In addition, current or historical information related to a driving mode, operational goals, aspects of the environment, and topological constraints associated with a particular environment may also be utilized to instruct modifications to operations of the autonomous vehicle in other similar environments, even in the absence of such current or historical information received directly from such similar environments.

In one embodiment, the controller of the computing platform is configured to selectively engage, selectively disengage, control, or otherwise communicate with vehicle systems of the vehicle. The controller is coupled to (e.g., communicably coupled to) the powertrain (e.g., the engine, the power divider, the engine clutch, electric motor, the electromechanical transfer device (ETD), etc.), a user input/output device, such as user interface, various sensors, a brake, a battery management system (BMS), if any, etc. By way of example, the controller may send and receive signals (e.g., control signals) to the powertrain based on the settings to the one or more vehicle systems.

The ECU may further include electronic stability controls (ESC) configured to monitor vehicle operation status using signals from the speed sensor and control the stability of the vehicle operation whenever needed such as by activating anti-lock brakes (ABS), traction controls or the like based on the selected driving mode of the vehicle. Configurations and settings of the ESC may be stored as ESC configuration data locally in a non-volatile storage medium.

The ECUs may further include an autonomous driving controller (ADC) configured to monitor and control the autonomous driving features of the vehicle, which may vary based on the particular driving mode that is selected. Autonomous driving features may include lane keep assist, distance from other vehicles, adaptive cruise control, hands-off-wheel alert, autobraking, brake mitigation with multiple sensitivity levels or the like. Configurations and settings of the ADC may be stored as ADC configuration data in a non-volatile storage medium. The vehicle driving mode may include the ESC configuration including, settings for traction control, electronic stability control, ABS, electric machine regenerative braking or coast down control, and various other functions controlled by the ESC. The vehicle driving mode, when the vehicle is being driven in an autonomous mode, may further include the ADC configuration for the ADC including settings for lane keep assist, distance from other vehicles, adaptive cruise control, hands-off-wheel alert, autobraking, brake mitigation with multiple sensitivity levels or the like.

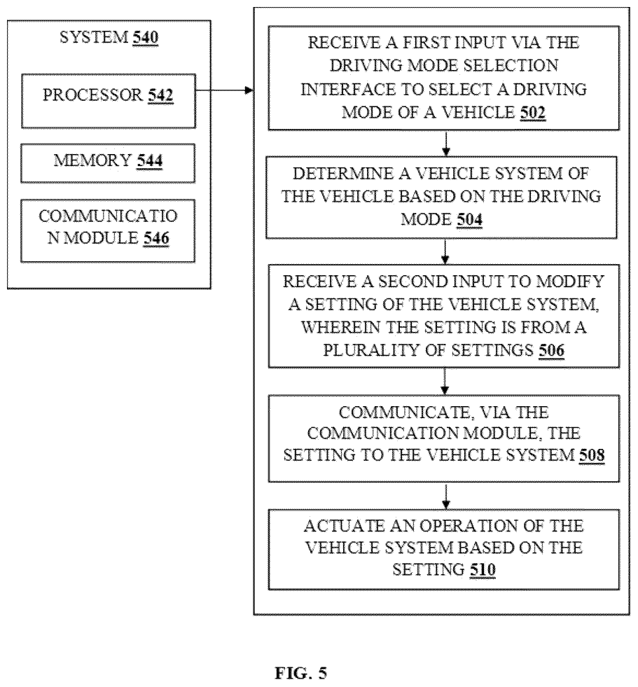

FIG. 5 illustrates a block diagram of the system implementing the method according to an embodiment. According to an embodiment, disclosed is system 540 comprising processor 542, memory 544, and communication module 546, wherein the memory 544 storing processor-executable instructions, which on execution, cause the processor to: receive a first input via the driving mode selection interface to select a driving mode of a vehicle 502, determine a vehicle system of the vehicle based on the driving mode 504, receive a second input to modify a setting of the vehicle system, wherein the setting is from a plurality of settings 506, communicate, via the communication module, the setting to the vehicle system 508, and actuate an operation of the vehicle system based on the setting 510.

According to an embodiment of the system, the processor is configured to display selectable driving modes on a display screen. The driving mode selection interface may allow an occupant of the vehicle to select one of the driving modes from the display screen. The display screen may be a screen of one of an infotainment system of the vehicle, and an application on a mobile device.

According to an embodiment of the system, the driving mode may comprise one of an economy mode, a normal mode, a sport mode, a track mode, a turbo mode, a warp mode, a snow mode, and an off road mode. According to an embodiment of the system, the vehicle system may comprise one of an engine management system, a transmission system, a steering system, a throttle system, an automatic transmission system, a suspension system, a braking system, an ancillary system, and a sound system.

According to an embodiment of the system, the processor is configured to selectively operate a powertrain of the vehicle in a plurality of driving modes. According to an embodiment of the system, the processor is configured to provide a first threshold range for modification to a setting of a first vehicle system. According to an embodiment of the system, the processor is configured to determine a second threshold range for modification to a setting of a second vehicle system based on the modification to the setting of the first vehicle system.

According to an embodiment of the system, the processor is configured to initiate the driving mode in response to one of a user input to initiate the driving mode automatically based on an environmental condition. According to an embodiment of the system, the processor is configured to automatically and/or temporarily transition the vehicle from one driving mode to another driving mode based on one of a terrain change and past driving history over a route. According to an embodiment of the system, the processor is configured to define a user specific driving mode, based on training data related to a user usage characteristics of the vehicle system.

According to an embodiment of the system, the processor is configured to determine that the modification to the vehicle system conforms to safety metrics related to the vehicle system. According to an embodiment of the system, the processor is configured to calculate statistical data on an impact of the modification to the vehicle system, and wherein the statistical data is displayed on a display screen.

According to an embodiment of the system, the processor is configured to automatically suggest modifications to the setting of the vehicle system. According to an embodiment of the system, the processor is configured to download the setting to the vehicle system based on a particular driving mode preset by a user. According to an embodiment of the system, the processor is configured to modify vehicle warnings based on the selected driving mode. According to an embodiment of the system, the processor is configured to determine a safe driving speed of the vehicle based on one of a road condition of a road, an environmental factor of an environment, a traffic condition, vehicle proximity, and other vehicles on the road.

According to an embodiment of the system, the system is a part of the vehicle, and the vehicle may be one of an electric vehicle, a gas controlled vehicle, a hybrid vehicle, and an autonomous vehicle. According to an embodiment of the system, the processor is configured to engage the vehicle in an autonomous mode along with another driving mode. According to an embodiment of the system, the system further comprises a user profile data configured to control one or more operations of the vehicle when the vehicle is in an autonomous mode.

According to an embodiment of the system, when the driving mode selected is an autonomous driving mode, an artificial intelligence unit of the vehicle is configured to determine suitable sections of a route for driving the vehicle simultaneously in the autonomous driving mode and a driving mode with fast speed.

According to an embodiment of the system, the processor is configured to, in a state in which the vehicle is travelling in an autonomous driving mode, determine whether the second input received to modify the setting of the vehicle system is suitable to be applied along with the autonomous driving mode.

According to an embodiment of the system, the processor is configured to, in a state in which the vehicle is travelling in an autonomous driving mode, generate a customized transition plan for one or more vehicle systems for transitioning between the autonomous driving mode and the autonomous driving mode combined with the driving mode with fast speed according to one or more identified circumstantial factors.

According to an embodiment of the system, the processor is configured to implement a machine learning mechanism to learn the one or more identified circumstantial factors and the customized transition plan for the one or more vehicle systems, and minimum and maximum transition periods required for each of the one or more vehicle systems.

According to an embodiment of the system, the system further comprises one or more machine learning models aided by artificial intelligence. The machine learning models may be trained on the first input and the second input. The machine learning models may be configured to predict, based on the first input and the second input, an optimized setting to the vehicle system. The machine learning models may be trained on historical data comprising user preference data, route data, one or more of vehicle parameters, and occupant prior travel history data. The machine learning models are configured to continuously learn, and update as new data is collected, improving accuracy of modifications of the vehicle system in a particular driving mode over time through adaptive algorithms.

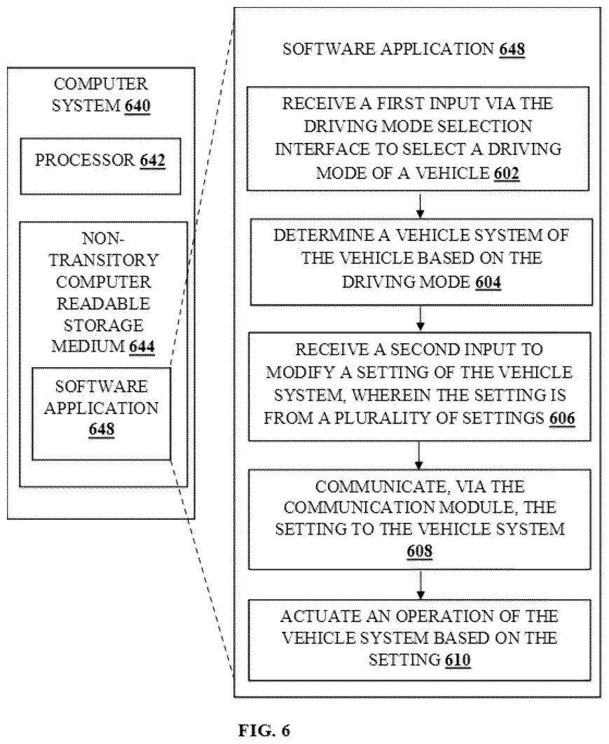

FIG. 6 illustrates a block diagram of the method executed by the non-transitory computer-readable storage medium according to an embodiment.

According to an embodiment, disclosed is non-transitory computer-readable storage medium 644 having stored thereon instructions executable by computer system 640 to perform operations comprising: receiving a first input via a driving mode selection interface to select a driving mode of a vehicle at step 602; determining a vehicle system of the vehicle based on the driving mode at step 604; receiving a second input to modify a setting of the vehicle system, wherein the setting is from a plurality of settings at step 606; communicating, via a communication module, the setting to the vehicle system at step 608; and actuating an operation of the vehicle system based on the setting at step 610. A software application 648 may be stored on non-transitory computer-readable storage medium 644 and executed by processor 642 of computer system 640.

In an embodiment, non-transitory computer-readable storage medium 644 further comprises instructions to perform operations comprising displaying selectable driving modes on a display screen. In an embodiment, non-transitory computer-readable storage medium 644 further comprises instructions to perform operations comprising providing a first threshold range for modification to a setting of a first vehicle system. In an embodiment, non-transitory computer-readable storage medium 644 further comprises instructions to perform operations comprising determining a second threshold range for modification to a setting of a second vehicle system based on the modification to the setting of the first vehicle system.

In an embodiment, non-transitory computer-readable storage medium 644 further comprises instructions to perform operations comprising engaging the vehicle in an autonomous mode along with another driving mode.

In an embodiment, non-transitory computer-readable storage medium 644 further comprises instructions to perform operations comprising one or more machine learning models aided by artificial intelligence. The machine learning models may be trained on the first input and the second input. The machine learning models may be configured to predict based on the first input and the second input, an optimized setting to the vehicle system.

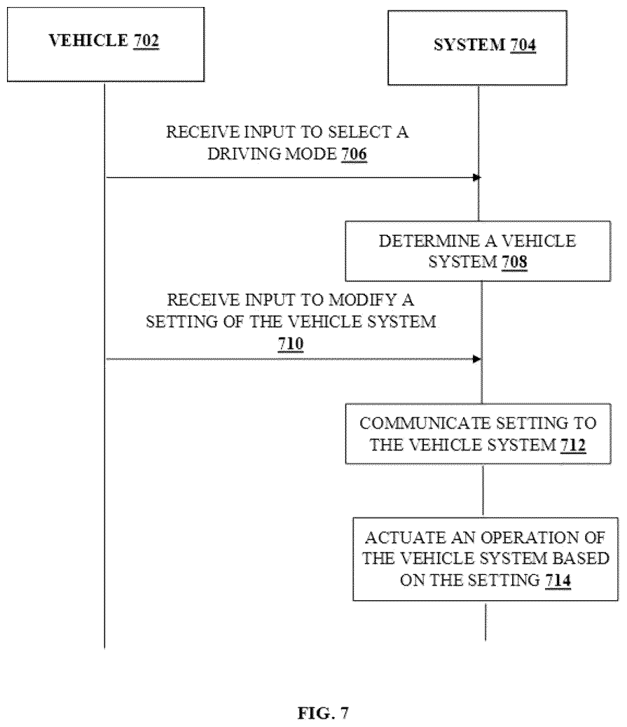

As an example, FIG. 7 illustrates a communication flow between the driving mode selection system 704 and a vehicle 702 according to one or more embodiments. At step 706, the system 704 receives a first input via the driving mode selection interface to select a driving mode of a vehicle 702 and determines a vehicle system of the vehicle based on the driving mode at step 708. At step 710, the system 704 receives a second input to modify a setting of the vehicle system, wherein the setting is from a plurality of settings. At step 712, the system 704 communicates, via the communication module, the setting to the vehicle system. At step 714, the system 704 actuates an operation of the vehicle system based on the setting.

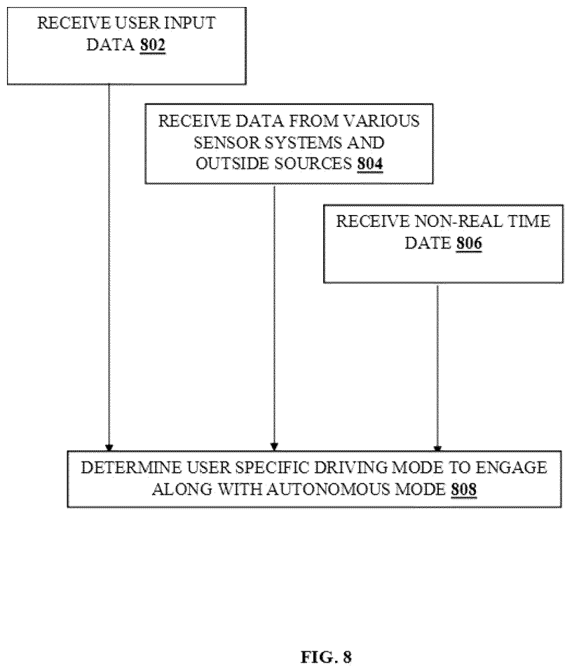

As an example, FIG. 8 illustrates a flow diagram for a vehicle driving in an autonomous mode along with another driving mode according to one or more embodiments.

FIG. 8 illustrates a flow chart where an autonomous vehicle collects data and builds user specific driving modes according to an embodiment. The process may start at block 802 with the controller of the vehicle driving in autonomous mode receiving user input data such as user identification, preferences, user preferred driving modes, and/or other information indicating a user's profile. A user's identification may include a user's name or a reference number. User preference data may include data indicating, for example, a preference for quicker acceleration, a driving mode the user may want to simultaneously engage in autonomous driving, a preference for frequent stops along a route, or a preference for maintaining a speed at the legal speed limit. The controller may also receive information indicating the levels of risks or aggressiveness that the user is willing to accept.

In block 804, the controller may continuously collect data from various sensor systems and outside sources regarding the vehicle's operations/conditions, objects in the vicinity of the vehicle, traffic, weather, and road conditions. The data may be collected by, for example, GPS, inertial sensors, lasers, radar, sonar, and acoustic sensors. Other feedback signals, such as input from sensors typical of non-autonomous vehicle driving, may also be read from the vehicle, such as from tire pressure sensors, engine temperature sensors, brake heat sensors, brake pad status sensors, tire tread sensors, fuel sensors, oil level and quality sensors, air quality sensors (for detecting temperature, humidity, or particulates in the air), etc. In block 806, the system may also retrieve various types of non-real time data (e.g., a detailed map) stored in the system or from remote information sources.

In block 808, the controller may determine one or more user specific driving modes based on the received user input, the data collected in real time and the non-real time data. The system may also build profiles for each individual user to facilitate storage of the data in local memory or remote storage and retrieval by authorized users. Each profile may include the user specific driving modes to be engaged along with autonomous driving mode and other user-related information.

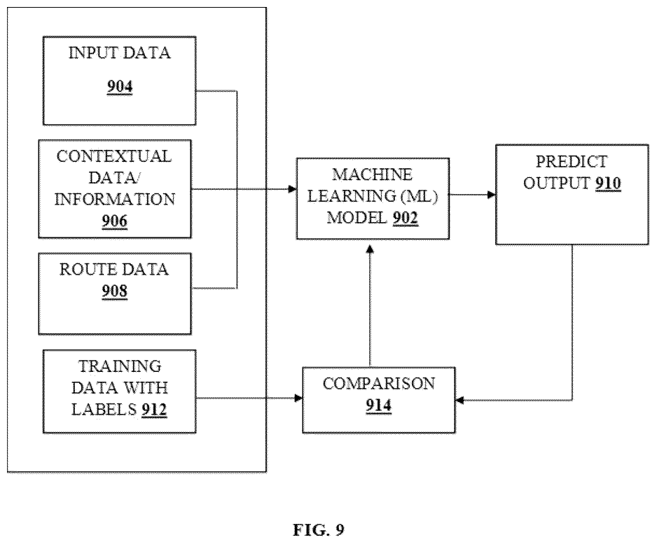

FIG. 9 illustrates an example block diagram for an Artificial Intelligence and Machine Learning (AI/ML) model used in a system according to an embodiment.

Referring to FIG. 9, the machine learning model 902 may take as input any data associated with an input data 904, contextual data/information 906, and route data 908 and learn to identify from the available information, input data that may provide an optimized setting to the vehicle system. The contextual data/information 906 may include environmental factors, such as ambient light levels, weather conditions, visibility range, and rate of precipitation, traffic conditions such as traffic density, traffic light status, lane occupancy, road closures, and alternate route suggestions, and historical factors that may affect settings to the vehicle system, such as user preference data, route data, one or more of vehicle parameters, and occupant prior travel history data. Route data 908 may comprise source details, destination details, distance to be travelled, estimated travel time, waypoints of interest, geographic location of the vehicle, navigation route, road type, and turn-by-turn directions. Training data with labels 912 may comprise, for example, a historical data of settings to the various vehicle systems and vehicle operating conditions such as acceleration metrics, engine status, steering angle, gear selection, headlight status, and a vehicle attachment. The systems and methods of the present disclosure may also provide data analytics information that may be used later to improve the prediction accuracy of identifying the optimized settings to the vehicle systems of the vehicle.

In an embodiment, during training, machine learning model 902 may process the training data sample (e.g., input data 904, contextual data/information 906, and route data 908), and, based on the current parameters of machine learning model 902, predict output 910 which may be an optimized setting to a vehicle system of the vehicle. In an embodiment, the real-time sensor data may be processed using one or more machine learning models 902, trained and based on similar types of data to correctly estimate the setting of a vehicle system in a given condition, such as in a particular environmental condition, for example, off roading conditions or rainy weather or snowy weather. For example, comparison 914 may be based on a loss function that measures a difference between the predicted/detected output and training data with labels 912. Based on the comparison 914 or the corresponding output of the loss function, a training algorithm may update the parameters of machine learning model 902 with the objective of minimizing the differences or loss between subsequent predicted output 910 and corresponding labels 912. By iteratively training in this manner, machine learning model 902 may “learn” from the different training data samples and become better at predicting output 910. In an embodiment, machine learning model 902 is trained using data which is specific to a vehicle system for which the model is used for predicting adjustments to the settings to provide accurate estimation of the settings to the vehicle systems. In an embodiment, machine learning model 902 is trained using data which is general to a vehicle system for which the model is used for predicting adjustments to the settings to provide accurate estimation of the settings to the vehicle systems. In an embodiment, the setting to the vehicle system may be given weights and provided as an input to the AI/ML system.

Through training, machine learning model 902 may learn to identify predictive and non-predictive features and apply the appropriate weights to the features to optimize predictive accuracy of machine learning model 902. In embodiments where supervised learning is used and each training data sample has a label, the training algorithm may iteratively process each training data sample and generate a predicted output 910, which involves optimized settings to the vehicle system. Based on the comparison 914 results, the training algorithm may adjust machine learning model 902 parameters/configurations (e.g., weights) accordingly to minimize the differences between the generated predicted output 910 and the corresponding labels 912. A suitable machine learning model and training algorithm may be used, including, e.g., neural networks, decision trees, clustering algorithms, decision matrix algorithms, and any other suitable machine learning techniques. Once trained, machine learning model 902 may take input data and determine an optimized setting of a vehicle system along with their corresponding confidence score. In an embodiment, machine learning model 902 is an artificial neural networks (ANN) model.

In an embodiment, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In some embodiments, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In some embodiments, the machine learning model has a feedback loop, wherein an output from a previous step is fed back to the machine learning model in real-time to improve the performance and accuracy of the output of a next step.

In some embodiments, the machine learning model has a feedback loop, wherein the learning is further reinforced with a reward for each true positive of the output of the system.

In some embodiments, the machine learning model comprises a recurrent neural network model.

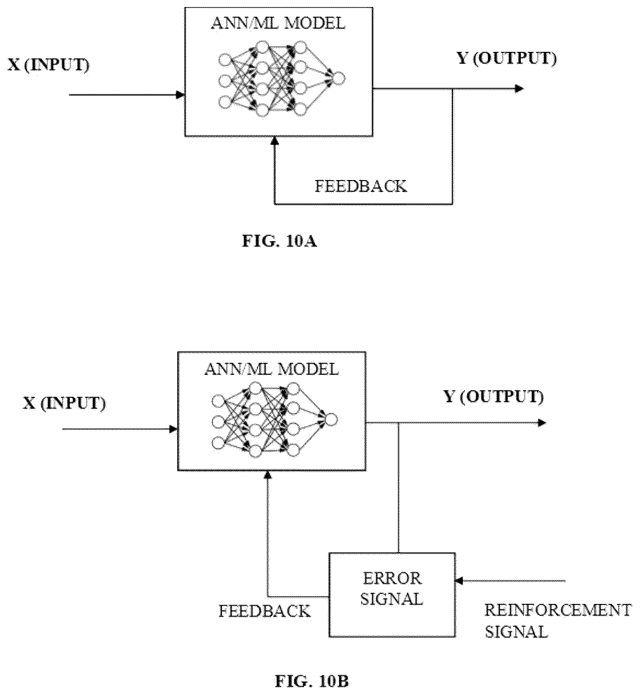

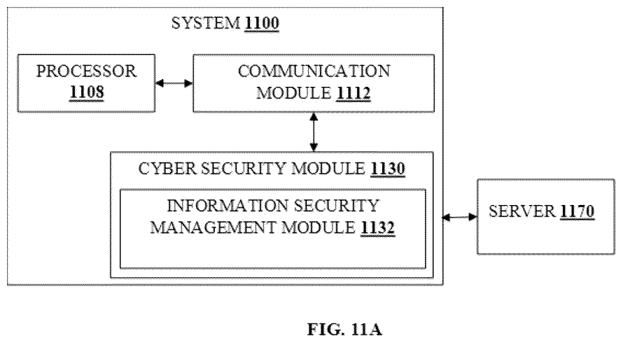

FIG. 10A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. In an embodiment, the output layer may predict a setting of a vehicle system of the vehicle.

In an embodiment, ANN may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the machine learning model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (e.g., settings to a vehicle system) are used that are meant for the model to learn. Afterward, the model is tested using unlabelled data. By using, for example, deep learning and neural networks, the model can then make predictions on whether the desired concept/s (e.g., prediction of a setting to a vehicle system) are in unlabelled data. Each data is given a probability score where higher scores represent a higher level of confidence in the models' predictions. Where a model gives the data a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 10B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

FIG. 11A illustrates the block diagram of the cyber security module in view of the system and server according to an embodiment.

Referring to FIG. 11A, system 1100 comprising processor 1108, communication module 1112, cyber security module 1130, and information security management module 1132 in communication with server 1170, is shown. In an embodiment, FIG. 11A shows the block diagram of the cyber security module. The communication of data between the system 1100 and the server 1170 through the communication module 1112 is first verified by the information security management module 1132 before being transmitted from the system to the server or from the server to the system. The information security management module is operable to analyze the data for potential cyber security threats, to encrypt the data when no cyber security threat is detected, and to transmit the data encrypted to the system or the server.

FIG. 11B shows an embodiment of the cyber security module, in accordance with some embodiments of the present disclosure.

In an embodiment, the cyber security module further comprises an information security management module 1132 providing isolation between the system and the server. FIG. 11B shows the flowchart of securing the data through the cyber security module 1130. At step 1140, the information security management module is operable to receive data from the communication module. At step 1141, the information security management module exchanges a security key at a start of the communication between the communication module and the server. At step 1142, the information security management module receives a security key from the server. At step 1143, the information security management module authenticates an identity of the server by verifying the security key. At step 1144, the information security management module analyzes the security key for potential cyber security threats. At step 1145, the information security management module negotiates an encryption key between the communication module and the server. At step 1146, the information security management module receives the encrypted data. At step 1147, the information security management module transmits the encrypted data to the server when no cyber security threat is detected.

FIG. 11C shows another embodiment of the cyber security module, in accordance with some embodiments of the present disclosure.

In an embodiment, FIG. 11C shows the flowchart of securing the data through the cyber security module 1130. At step 1151, the information security management module 1132 is operable to: exchange a security key at a start of the communication between the communication module and the server. At step 1152, the information security management module receives a security key from the server. At step 1153, the information security management module authenticates an identity of the server by verifying the security key. At step 1154, the information security management module analyzes the security key for potential cyber security threats. At step 1155, the information security management module negotiates an encryption key between the communication module and the server. At step 1156, the information security management module receives encrypted data. At step 1157, the information security management module decrypts the encrypted data, and performs an integrity check of the decrypted data. At step 1158, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 11A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. Signing identity is referred to as the common name of certificates.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting a Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-97. (canceled)

98. A system comprising:
a driving mode selection interface;
a communication module; and
a processor storing instructions in a non-transitory memory that, when executed, cause the processor to:
receive a first input via the driving mode selection interface to select a driving mode of a vehicle;
determine a vehicle system of the vehicle based on the driving mode;
receive a second input to modify a setting of the vehicle system, wherein the setting is from a plurality of settings;
communicate, via the communication module, the setting to the vehicle system; and
actuate an operation of the vehicle system based on the setting.

99. The system of claim 98, wherein the processor is configured to display selectable driving modes on a display screen.

100. The system of claim 98, wherein the driving mode comprises one of an economy mode, a normal mode, a sport mode, a track mode, a turbo mode, a warp mode, a snow mode, and an off road mode.

101. The system of claim 98, wherein the vehicle system comprises one of an engine management system, a transmission system, a steering system, a throttle system, an automatic transmission system, a suspension system, a braking system, an ancillary system, and a sound system.

102. The system of claim 98, wherein the processor is configured to provide a first threshold range for modification to a setting of a first vehicle system.

103. The system of claim 98, wherein the processor is configured to initiate the driving mode in response to one of a user input to initiate the driving mode and automatically based on an environmental condition.

104. The system of claim 98, wherein the processor is configured to temporarily transition the vehicle from one driving mode to another driving mode based on one of a terrain change and past driving history over a route.

105. The system of claim 98, wherein the processor is configured to modify vehicle warnings based on the selected driving mode.

106. The system of claim 98, further comprises a mobile device having a device processor and a device memory, wherein the device memory stores driving mode details of the vehicle and wherein the device processor is configured to wirelessly transfer the driving mode details to the vehicle.

107. The system of claim 98, wherein the processor is configured to engage the vehicle in an autonomous mode along with another driving mode.

108. The system of claim 98, wherein when the driving mode selected is an autonomous driving mode, an artificial intelligence unit of the vehicle is configured to determine suitable sections of a route for driving the vehicle simultaneously in the autonomous driving mode and a driving mode with fast speed.

109. The system of claim 98, wherein the processor is configured to, in a state in which the vehicle is travelling in an autonomous driving mode, generate a customized transition plan for one or more vehicle systems for transitioning between the autonomous driving mode and the autonomous driving mode combined with the driving mode with fast speed according to one or more identified circumstantial factors.

110. The system of claim 98, wherein the system further comprises one or more machine learning models aided by artificial intelligence.

111. The system of claim 110, wherein the machine learning models are trained on the first input and the second input.

112. The system of claim 111, wherein the machine learning models are configured to predict based on the first input and the second input, an optimized setting to the vehicle system.

113. A method comprising:
receiving a first input via a driving mode selection interface to select a driving mode of a vehicle;
determining a vehicle system of the vehicle based on the driving mode;
receiving a second input to modify a setting of the vehicle system, wherein the setting is from a plurality of settings;
communicating, via a communication module, the setting to the vehicle system; and
actuating an operation of the vehicle system based on the setting.

114. The method of claim 113, further comprising displaying selectable driving modes on a display screen.

115. The method of claim 113, further comprising calculating statistical data on an impact of the modification to the vehicle system and displaying the statistical data on a display screen.

116. The method of claim 113, further comprising downloading the setting to the vehicle system based on a particular driving mode preset by a user.

117. A non-transitory computer-readable medium having stored thereon instructions executable by a computer system to perform operations comprising:
receiving a first input via a driving mode selection interface to select a driving mode of a vehicle;
determining a vehicle system of the vehicle based on the driving mode;
receiving a second input to modify a setting of the vehicle system, wherein the setting is from a plurality of settings;
communicating, via a communication module, the setting to the vehicle system; and
actuating an operation of the vehicle system based on the setting.
